(19) United States
(12) Patent Application Publication
(10) Pub. No.: US 2025/0202848 A1
(43) Pub. Date: Jun. 19, 2025

(54) DATA PROCESSING METHOD AND APPARATUS, COMPUTER DEVICE, AND READABLE STORAGE MEDIUM

(71) Applicant: TENCENT TECHNOLOGY (SHENZHEN) COMPANY LIMITED, Shenzhen (CN)

(72) Inventors: Sha SHA, Shenzhen (CN); Caijun WANG, Shenzhen (CN); Xianmin XIAO, Shenzhen (CN)

(21) Appl. No.: 19/068,118

(22) Filed: Mar. 3, 2025

Related U.S. Application Data
(63) Continuation of application No. PCT/CN2023/131595, filed on Nov. 14, 2023.

(30) Foreign Application Priority Data
Feb. 21, 2023 (CN) 202310179862.4

(51) Int. Cl. H04L 51/04; G06F 3/04842; G06F 3/04845; G06T 13/80; H04L 51/10; H04L 51/224

(52) U.S. Cl. CPC H04L 51/04; G06F 3/04842; G06F 3/04845; G06T 13/80; H04L 51/10; H04L 51/224

(57) ABSTRACT

A data processing method includes displaying, in an application interface, a message list including a message preview box that includes an avatar area and a target area not overlapping the avatar area, displaying, in the message preview box, a preview message generated based on an original interaction message, displaying, in the target area, a resource animation including a virtual image and determined based on media content in the original interaction message and a media format of the media content, and executing, in response to a trigger operation on the resource animation, a message service associated with the original interaction message.

### CROSS-REFERENCE TO RELATED APPLICATIONS

This application is a continuation of International Application No. PCT/CN2023/131595, filed on Nov. 14, 2023, which claims priority to Chinese Patent Application No. 2023101798624, entitled “DATA PROCESSING METHOD AND APPARATUS, COMPUTER DEVICE, AND READABLE STORAGE MEDIUM” and filed with the China National Intellectual Property Administration on Feb. 21, 2023, the entire contents of which are incorporated herein by reference.

### FIELD OF THE TECHNOLOGY

This application relates to the field of Internet technologies, and, in particular, to a data processing method and apparatus, a computer device, and a readable storage medium.

### BACKGROUND OF THE DISCLOSURE

In an existing message notification manner, a new message may be prompted by displaying a red dot in a message preview box. However, the red dot cannot reflect specific content of the new message, and new messages sent by all people are presented by using a same red dot. Consequently, messages that need to be focused on cannot be highlighted. As a result, a new message notification manner is excessively simple. In addition, the red dot in the message preview box cannot perform any operation on the new message, and only plays a role of prompting that there is the new message. The new message can be operated only after the message preview box is clicked/tapped to enter a chat. This reduces efficiency of processing the new message.

### SUMMARY

In accordance with the disclosure, there is provided a data processing method including displaying, in an application interface, a message list including a message preview box that includes an avatar area and a target area not overlapping the avatar area, displaying, in the message preview box, a preview message generated based on an original interaction message, displaying, in the target area, a resource animation including a virtual image and determined based on media content in the original interaction message and a media format of the media content, and executing, in response to a trigger operation on the resource animation, a message service associated with the original interaction message.

Also in accordance with the disclosure, there is provided a computer device including a processor and a memory storing a computer program that, when executed by the processor, causes the computer device to display, in an application interface, a message list including a message preview box that includes an avatar area and a target area not overlapping the avatar area, display, in the message preview box, a preview message generated based on an original interaction message, display, in the target area, a resource animation including a virtual image and determined based on media content in the original interaction message and a media format of the media content, and execute, in response to a trigger operation on the resource animation, a message service associated with the original interaction message.

Also in accordance with the disclosure, there is provided a non-transitory computer-readable storage medium storing a computer program that, when executed by a processor, causes a computer device including the processor to display, in an application interface, a message list including a message preview box that includes an avatar area and a target area not overlapping the avatar area, display, in the message preview box, a preview message generated based on an original interaction message, display, in the target area, a resource animation including a virtual image and determined based on media content in the original interaction message and a media format of the media content, and execute, in response to a trigger operation on the resource animation, a message service associated with the original interaction message.

### BRIEF DESCRIPTION OF THE DRAWINGS

To describe the technical solutions in the embodiments of this application more clearly, the following briefly describes the accompanying drawings for describing the embodiments. Apparently, the accompanying drawings in the following description show merely some embodiments of this application, and a person of ordinary skill in the art may derive other drawings from the accompanying drawings without creative efforts.

FIG. 1 is a schematic structural diagram of a network architecture according to an embodiment of this application.

FIG. 2 is a schematic flowchart of a data processing method according to an embodiment of this application.

FIG. 3 is a schematic diagram showing a scenario of displaying a first resource animation according to an embodiment of this application.

FIG. 4 is a schematic diagram showing a scenario of an object image according to an embodiment of this application.

FIG. 5 is a schematic flowchart of a data processing method according to an embodiment of this application.

FIG. 6 is a schematic flowchart of processing an expression message according to an embodiment of this application.

FIG. 7 is a schematic diagram showing a scenario of processing a document message according to an embodiment of this application.

FIG. 8 is a schematic diagram showing a scenario of processing a picture message according to an embodiment of this application.

FIG. 9 is a schematic diagram showing a scenario of processing a sticker message according to an embodiment of this application.

FIG. 10 is a schematic diagram showing a scenario of processing a video message according to an embodiment of this application.

FIG. 11 is a schematic diagram showing a scenario of processing an audio message according to an embodiment of this application.

FIG. 12 is a schematic diagram showing a scenario of processing a gift message according to an embodiment of this application.

FIG. 13 is a schematic diagram showing a scenario of processing a red packet message according to an embodiment of this application.

FIG. 14 is a schematic diagram showing a scenario of processing a poke message according to an embodiment of this application.

FIG. 15 is a schematic flowchart of triggering a first resource animation according to an embodiment of this application.

FIG. 16 is a schematic flowchart of a data processing method according to an embodiment of this application.

FIG. 17 is a schematic diagram showing a scenario of a message management database according to an embodiment of this application.

FIG. 18 is a schematic flowchart of displaying a first resource animation according to an embodiment of this application.

FIG. 19 is a schematic structural diagram of a data processing apparatus according to an embodiment of this application.

FIG. 20 is a schematic structural diagram of a computer device according to an embodiment of this application.

### DESCRIPTION OF EMBODIMENTS

The technical solutions in the embodiments of this application are described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the scope of this application.

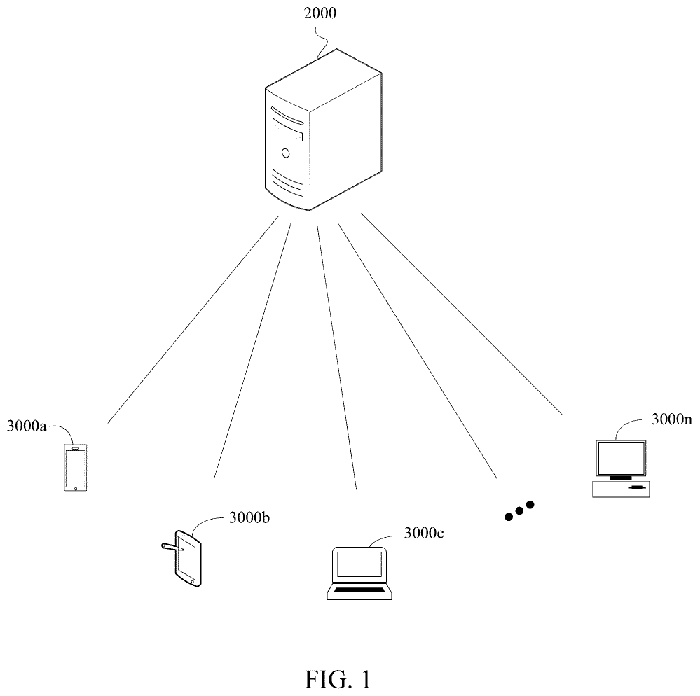

Specifically, FIG. 1 is a schematic structural diagram of a network architecture according to an embodiment of this application. As shown in FIG. 1, the network architecture may include a server 2000 and a terminal device cluster. The terminal device cluster may specifically include one or more terminal devices. A quantity of terminal devices in the terminal device cluster is not limited herein. As shown in FIG. 1, a plurality of terminal devices may specifically include a terminal device 3000a, a terminal device 3000b, a terminal device 3000c, . . . , and a terminal device 3000n. The terminal device 3000a, the terminal device 3000b, the terminal device 3000c, . . . , and the terminal device 3000n may be separately directly or indirectly connected to the server 2000 through a network in a wired or wireless communication manner, so that each terminal device may exchange data with the server 2000 through the network connection.

Each terminal device in the terminal device cluster may include: an intelligent terminal having a data processing function such as a mobile phone, a tablet computer, a notebook computer, a desktop computer, an intelligent speech interaction device, an intelligent appliance (for example, an intelligent television), a wearable device, a vehicle-mounted terminal, or an aircraft. As shown in FIG. 1, an application client may be installed on each terminal device in the terminal device cluster. When running in each terminal device, the application client may exchange data with the server 2000 shown in FIG. 1 respectively. The application client may specifically include a client having a data processing function such as a vehicle-mounted client, a smart home client, an entertainment client (for example, a game client), a multimedia client (for example, a video client), a social client, or an information client (for example, a news client). The application client may be integrated into a client (for example, the social client), or the application client may be an independent client (for example, the news client). A type of the application client is not limited in embodiments of this application.

As shown in FIG. 1, the server 2000 may be a server corresponding to the application client. The server 2000 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

For ease of understanding, in embodiments of this application, one terminal device may be selected from the plurality of terminal devices shown in FIG. 1 as a target terminal device. In embodiments of this application, one terminal device may be selected from the plurality of terminal devices shown in FIG. 1 as a sample terminal device. For example, in embodiments of this application, the terminal device 3000a shown in FIG. 1 may be used as the sample terminal device. In embodiments of this application, the terminal device 3000c shown in FIG. 1 may be used as the target terminal device. An application client having a data processing function may be installed in each of the target terminal device and the sample terminal device. In this case, the target terminal device may exchange data with the server 2000 by using the application client, and the sample terminal device may exchange data with the server 2000 by using the application client.

For ease of understanding, in embodiments of this application, a user may be referred to as an interaction object. The interaction object may be a user that logs in to the application client, a user corresponding to the target terminal device may be referred to as a target interaction object, and a user corresponding to the sample terminal device may be referred to as a sample interaction object. The target interaction object not only may be used as a message receiver, but also may be used as a message sender. For example, the target interaction object may be used as the message receiver by using the application client in the target terminal device, and may also be used as the message sender by using the application client in the target terminal device. Similarly, the sample interaction object not only may be used as a message sender, but also may be used as a message receiver. For example, the sample interaction object may be used as the message sender by using the application client in the sample terminal device, and may also be used as the message receiver by using the application client in the sample terminal device. An application client corresponding to the server 2000 runs on both the target terminal device and the sample terminal device. Sending and receiving of an interaction message (for example, a first original interaction message) between the target terminal device and the sample terminal device may be implemented by using the application client. For ease of understanding, in embodiments of this application, an example in which the target interaction object is a message sender and the sample interaction object is a message receiver is configured for description.

For example, the message sender (namely, the target interaction object) and the message receiver (namely, the sample interaction object) may be connected by the server 2000. The target interaction object may send the first original interaction message by using the application client in the target terminal device. The server 2000 may synchronize the first original interaction message from the target terminal device to the sample terminal device, and display a first preview message in a message list in an application interface of the sample terminal device. The sample terminal device may display the first preview message in a message preview box of the message list, display, in a target area of the message preview box, a first resource animation including a virtual image corresponding to the interaction object, and execute, in response to a trigger operation on the first resource animation, a message service associated with the first original interaction message. The target area does not overlap an avatar area in the message preview box, and the first resource animation is generated based on media content included in the first original interaction message and a media format of the media content.

In some embodiments, a virtual social scene is displayed in the application interface, the message list may be displayed in the virtual social scene, the virtual image displayed in the message list may also be considered as a virtual image displayed in the virtual social scene, and the virtual image may be displayed in the virtual social scene and perform interaction in the virtual social scene. The virtual social scene is a 3D (namely, an abbreviation of three dimensions) virtual space with link awareness and sharing features based on future Internet or an interactive, immersive, and cooperative world that presents convergence and physical persistence features by using a virtual enhanced physical reality. As a physical universe is a series of worlds interconnected in space, the virtual social scene may also be considered as a set of a plurality of worlds.

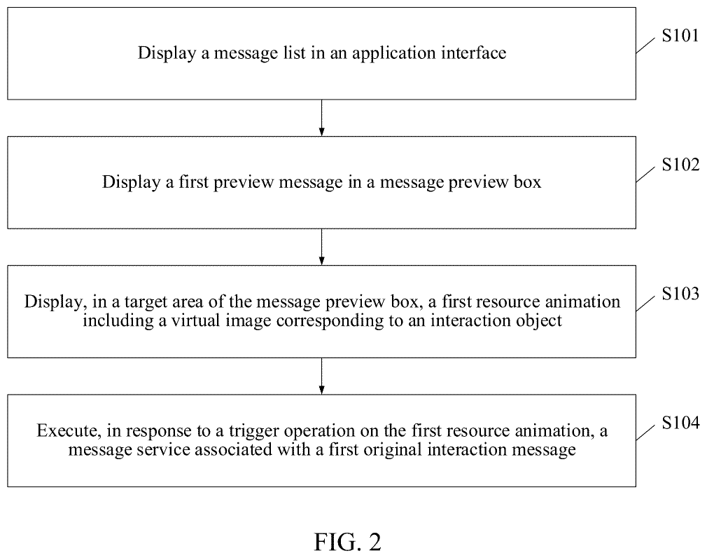

Further, FIG. 2 is a schematic flowchart of a data processing method according to an embodiment of this application. The method may be performed by a server, may be performed by a terminal device, or may be jointly performed by the server and the terminal device. The server may be the server 2000 in the foregoing embodiment corresponding to FIG. 1, and the terminal device may be the sample terminal device or the target terminal device in the foregoing embodiment corresponding to FIG. 1. For ease of understanding, in embodiments of this application, an example in which the method is performed by the terminal device is configured for description. The data processing method may include the following operation S101 to operation S104.

Operation S101: Display a message list in an application interface.

The message list may include a message preview box associated with an interaction object, and the message list may further include a message preview box associated with another interaction object (for example, a candidate interaction object). In other words, the message list may include S message preview boxes. S may be a non-negative integer. When S is a positive integer, the S message preview boxes may include the message preview box associated with the interaction object, and the S message preview boxes may be sorted from top to bottom by timestamps.

The message preview box includes an avatar area and a target area that does not overlap the avatar area. The avatar area is configured for displaying an avatar of the interaction object. The displayed avatar of the interaction object may be an actual image or may be a virtual avatar.

The message preview box may also be referred to as a message item, a chat item, or the like. Clicking/Tapping an item is opening all in one (AIO). The AIO refers to a public chat window component, that is, the application client participates in a plurality of different types of sessions such as friends, groups, and public accounts. To provide unified interaction experience, the application client provides a chat window component that are shared by different sessions, and behavior habits such as an input operation and a click/tap operation on the component may be considered to be consistent.

Operation S102: Display a first preview message in the message preview box.

The first preview message is generated based on a first original interaction message sent by the interaction object. When the terminal device is the sample terminal device, the first original interaction message may be sent by a target interaction object. When the terminal device is the target terminal device, the first original interaction message may be sent by a sample interaction object. For ease of understanding, in embodiments of this application, an example in which the terminal device is the sample terminal device, and the first original interaction message is sent by the target interaction object is configured for description. In this case, the target interaction object may be referred to as an interaction object for short, and the sample terminal device may be referred to as a terminal device for short.

The message preview box includes the avatar area and the target area that does not overlap the avatar area, that is, the target area may be an area other than the avatar area in the message preview box. In some embodiments, in S102, the displaying a first preview message in the message preview box may be displaying the first preview message in a preset area of the target area.

After receiving the first original interaction message sent by the interaction object, the terminal device may display the message preview box in the message list (that is, generation of the message preview box in the message list is triggered by using the first original interaction message), and then display the first preview message corresponding to the first original interaction message in the message preview box. In some embodiments, before receiving the first original interaction message sent by the interaction object, the terminal device may alternatively display the message preview box in the message list (that is, generation of the message preview box in the message list is triggered by using a historical interaction message instead of the first original interaction message, and the historical interaction message may be an interaction message whose interaction time is earlier than that of the first original interaction message), and then directly display the first preview message corresponding to the first original interaction message in the message preview box.

The interaction object that performs message exchange with the sample interaction object may further include an interaction object (for example, a candidate interaction object) other than the target interaction object. The message preview box may be further configured for displaying another interaction message (for example, a candidate interaction message sent by the candidate interaction object) sent by the another interaction object (for example, the candidate interaction object).

If the first original interaction message is a plain text message (namely, a regular text message), after receiving the first original interaction message sent by the target terminal device by using the server, the terminal device may determine a character length of the first original interaction message. Further, if the character length of the first original interaction message is greater than a length threshold, the first original interaction message is different from the first preview message. In this case, the terminal device may cut the first original interaction message, to obtain the first preview message corresponding to the first original interaction message. In some embodiments, if the character length of the first original interaction message is less than or equal to the length threshold, the first original interaction message is the same as the first preview message. The length threshold is determined by using a device width of the terminal device. A specific value of the length threshold is not limited in embodiments of this application. For example, the length threshold may be equal to 18 characters. For example, the first original interaction message may be “Good night,” and a character length of “Good night” is less than or equal to the length threshold. In this case, the first preview message may be “Good night.” For another example, the first original interaction message may be “I went to an amusement park with him today, and we had a good time!”. A character length of “I went to an amusement park with him today, and we had a good time!” is greater than the length threshold. In this case, the first preview message may be “I went to an amusement park with him today, and we . . . . ”

In some embodiments, if the first original interaction message is not a plain text message, the terminal device may generate the first preview message corresponding to the first original interaction message according to the media content included in the first original interaction message. For example, if the first original interaction message includes document content, the first preview message corresponding to the first original interaction message may be “[document] XXX,” where “XXX” may be a title of the document content. For another example, if the first original interaction message includes video content, the first preview message corresponding to the first original interaction message may be “[video].” For another example, if the first original interaction message includes image content, the first preview message corresponding to the first original interaction message may be “[image].” For another example, if the first original interaction message includes image content, and the first original interaction message includes a text message (for example, the first original interaction message may be “Look at a photo I took [image]”), the first preview message corresponding to the first original interaction message may be “Look at a photo I took [image],” where “[image]” in the first original interaction message is the image content, and “[image]” in the first preview message is the text message. For another example, if the first original interaction message includes two pieces of image content, the first preview message corresponding to the first original interaction message may be “[image] [image].”

Operation S103: Display, in the target area of the message preview box, a first resource animation including a virtual image corresponding to the interaction object.

Specifically, the terminal device may display, in the target area of the message preview box, a first resource sub-animation formed by the virtual image corresponding to the interaction object. At the same time, the terminal device may display a second resource sub-animation in the target area, and the second resource sub-animation is generated based on a message virtual resource that may be configured for interacting with the virtual image. The first resource animation includes the first resource sub-animation and the second resource sub-animation, that is, the first resource sub-animation and the second resource sub-animation may be collectively referred to as the first resource animation. The target area does not overlap the avatar area in the message preview box. The message virtual resource in the second resource sub-animation is determined based on the media content included in the first original interaction message and the media format of the media content. Correspondingly, the first resource animation is determined based on the media content included in the first original interaction message and the media format of the media content.

In some embodiments, the terminal device may display, in the target area of the message preview box, the first resource sub-animation formed by the virtual image corresponding to the interaction object, and then determine the first resource sub-animation as the first resource animation including the virtual image corresponding to the interaction object.

The first resource animation may be dynamic or may be static. Both the first resource sub-animation and the second resource sub-animation may be dynamic. In some embodiments, both the first resource sub-animation and the second resource sub-animation may be static. In some embodiments, the first resource sub-animation may be dynamic, and the second resource sub-animation may be static. In some embodiments, the first resource sub-animation may be static, and the second resource sub-animation may be dynamic.

When the first resource animation is displayed in the target area, the terminal device may slide the message preview box in the application interface in response to a sliding operation on the application interface, that is, slide the target area in the message preview box. Further, the terminal device may display, in the target area that is being slid, the first resource animation including the virtual image corresponding to the interaction object. In other words, the first resource animation may scroll up and down with the message preview box.

The terminal device may display a preset message resource in the target area of the message preview box, obtain the first resource animation including the virtual image corresponding to the interaction object when the first original interaction message may trigger generation of the first resource animation including the virtual image corresponding to the interaction object, and update the preset message resource in the target area based on the first resource animation (namely, cancel displaying of the preset message resource and display the first resource animation). In some embodiments, without displaying the preset message resource in the target area of the message preview box, the terminal device may alternatively directly obtain the first resource animation including the virtual image corresponding to the interaction object when the first original interaction message may trigger generation of the first resource animation including the virtual image corresponding to the interaction object, and then display the first resource animation in the target area of the message preview box. In some embodiments, the terminal device may alternatively display the preset message resource in the target area of the message preview box when the first original interaction message cannot trigger generation of the first resource animation including the virtual image corresponding to the interaction object.

The media format of the media content included in the first original interaction message may be specified by using message_type. Because there may be one or more media formats of the media content included in the first original interaction message (that is, there may be one or more pieces of media content included in the first original interaction message), message_type associated with the first original interaction message may represent the one or more pieces of media content in the first original interaction message in a list manner. In this case, when message_type of an unread message (for example, the first original interaction message) is a regular text message (namely, a plain text message) (that is, when message_type indicates that the first original interaction message includes text content and does not include other content), a new message notification is in a manner of the preset message resource. When message_type of the unread message (for example, the first original interaction message) is not the regular text message (that is, when message_type indicates that the first original interaction message includes content other than text content, for example, the first original interaction message includes image content and the text content), the new message notification may be presented in a virtual image manner.

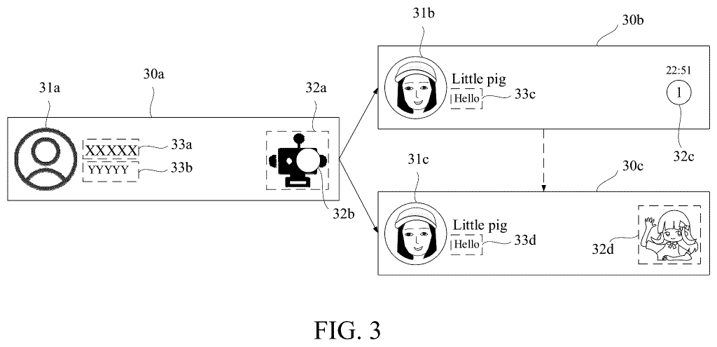

For ease of understanding, FIG. 3 is a schematic diagram showing a scenario of displaying a first resource animation according to an embodiment of this application. As shown in FIG. 3, a message preview box 30a may be the message preview box displayed in the message list. The message preview box 30a may include an avatar area 31a, a resource animation display area 32a, a default prompt display area 32b, an object nickname 33a, and a preview message 33b. The resource animation display area 32a may be configured for displaying a resource animation (for example, the first resource animation), the default prompt display area 32b may be configured for displaying the preset message resource, the object nickname 33a may be configured to for displaying an object nickname (for example, an application nickname of the interaction object in the application client), and the preview message 33b may be configured for displaying a preview message (for example, the first preview message). The resource animation display area 32a and the default prompt display area 32b belong to a target area of the message preview box 30a, and the target area may be an area other than the avatar area 31a in the message preview box 30a.

As shown in FIG. 3, a message preview box 30b may be a message preview box including the preset message resource. The message preview box 30b may include an avatar area 31b, a default prompt display area 32c, an object nickname “Little pig,” and a preview message 33c. As shown in FIG. 3, a message preview box 30c may be a message preview box including the first resource animation. The message preview box 30c may include an avatar area 31c, a resource animation display area 32d, an object nickname “Little pig,” and a preview message 33d.

The terminal device may directly display the message preview box 30b, may directly display the message preview box 30c, or may switch the message preview box 30b to the message preview box 30c after displaying the message preview box 30b. The message preview box 30b (namely, a display manner of the preset message resource) and the message preview box 30c (namely, a display manner of the virtual image) are in a parallel relationship (namely, in a mutual exclusion relationship), and the two manners cannot be displayed simultaneously. When there is the virtual image, the preset message resource needs to be hidden, and the virtual image is displayed earlier than the preset message resource.

The virtual image corresponding to the interaction object may be determined by using an object image of the interaction object. For example, the object image of the interaction object may represent a super-image show created by the interaction object. The super-image show is an upgraded version of an image show, is exploration and trying from a two dimensional (2D) image show to a three dimensional (3D) image show, and may be generated by using a game rendering engine. When the interaction object updates the object image (for example, face sculpting or costume replacement), a flag value (namely, an object identifier of the virtual image) of an updated object image and an updated virtual image corresponding to the updated object image may be generated, so that the object image is updated, and resource animations associated with a same interaction message are different for a same interaction object under different costumes (that is, object images). For another example, the object image of the interaction object may represent an object behavior of the interaction object. For example, the object image of the interaction object may be generated based on a clicking/tapping behavior and a watching behavior of the interaction object in the application client. For another example, the object image of an interaction object may be determined by using an image uploaded by the interaction object, and the image may include the object image of the interaction object.

In this application, data related to the clicking/tapping behavior, the watching behavior, and the like is involved. When the foregoing embodiments of this application are applied to a specific product or technology, user permission or consent needs to be obtained, and the related data needs to be collected, used, and processed by complying with related laws and regulations and national standards in a country in which the related data is located. For example, the target terminal device may display prompt information “whether to record a current clicking/tapping behavior and watching behavior, and send recorded information to the server,” and only when authorization on a user (namely, the interaction object) corresponding to the target terminal device succeeds, the target terminal device may upload the object behavior to the server.

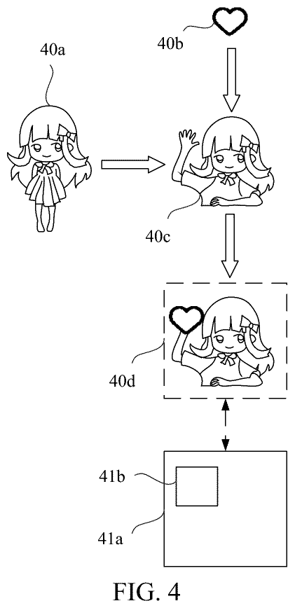

For ease of understanding, FIG. 4 is a schematic diagram showing a scenario of an object image according to an embodiment of this application. As shown in FIG. 4, the object image of the interaction object may be an object image 40a, and the virtual image that corresponds to the interaction object and that is generated according to the object image 40a may be a virtual image 40c. A posture of the virtual image 40c may be fixed (for example, raising a hand), or may not be fixed (for example, raising a hand or blocking a face). This is not limited in this application. For ease of understanding, in embodiments of this application, an example in which the posture of the virtual image is raising a hand is configured for description.

If the first resource animation includes the first resource sub-animation, the terminal device may generate the first resource sub-animation based on the virtual image 40c, where a region range in which the first resource sub-animation is displayed may be a region range 41a. In some embodiments, if the first resource animation includes the first resource sub-animation and the second resource sub-animation, the terminal device may generate the first resource sub-animation based on the virtual image 40c, generate the second resource sub-animation based on a message virtual resource 40b (an example in which the message virtual resource 40b is a heart is configured for description herein, and the message virtual resource 40b may alternatively be a virtual resource other than the heart), and then superimpose the first resource sub-animation and the second resource sub-animation, to obtain a first resource animation 40d.

As shown in FIG. 4, the first resource animation 40d may include the virtual image 40c and the message virtual resource 40b. The region range in which the first resource sub-animation is displayed may be the region range 41a, and a region range in which the second resource sub-animation is displayed may be a region range 41b. In other words, a region range in which the virtual image 40c is displayed may be the region range 41a, a region range in which the message virtual resource 40b is displayed may be the region range 41b, and a region range in which the first resource animation is displayed may be a union set of the region range 41a and the region range 41b.

Operation S104: Execute, in response to a trigger operation on the first resource animation, a message service associated with the first original interaction message.

Specifically, in an implementation, the executing a message service associated with the first original interaction message may be: displaying an interaction area associated with the interaction object, and displaying the first original interaction message in the interaction area.

In another implementation, the executing a message service associated with the first original interaction message may be: displaying media data associated with media content that is in the first original interaction message and that is in a triggerable media format.

Specifically, if the first resource animation is an untriggerable resource animation, the terminal device may display, in response to the trigger operation on the first resource animation, the interaction area associated with the interaction object. Further, the terminal device may display the first original interaction message in the interaction area. In some embodiments, if the first resource animation is a triggerable resource animation, the terminal device may display, in response to the trigger operation on the first resource animation, the media data associated with the media content that is in the first original interaction message and that is in the triggerable media format.

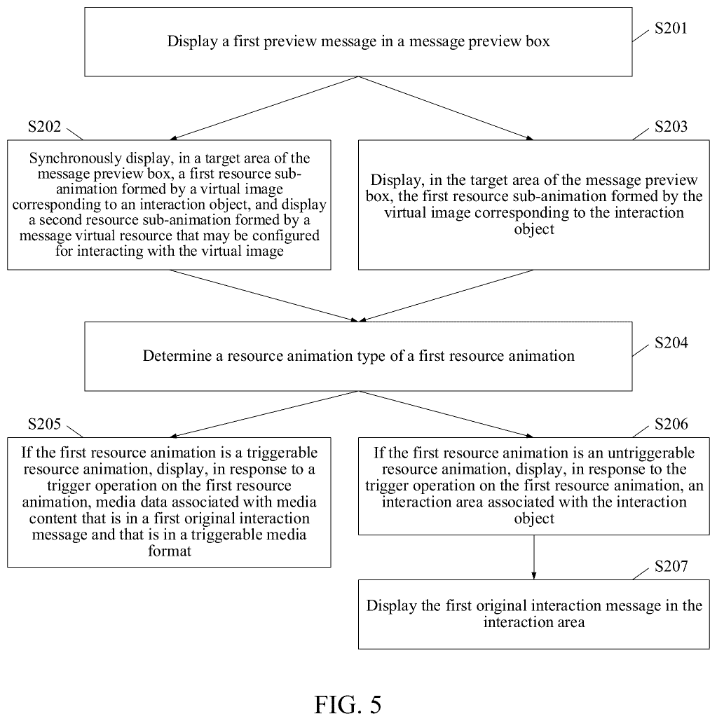

For a specific process in which the terminal device displays the media data associated with the media content that is in the first original interaction message and that is in the triggerable media format, reference may be made to descriptions of operation S205 in the following embodiment corresponding to FIG. 5.

In some embodiments, the terminal device may display, in response to a trigger operation on a non-target area in the message preview box, the interaction area associated with the interaction object. The non-target area may be an area other than an area in which the first resource animation is located in the message preview box. Further, the terminal device may display the first original interaction message in the interaction area.

Before responding to the trigger operation on the first resource animation (or the non-target area), the terminal device may continuously display the first resource animation in the target area, and then cancel displaying of the first resource animation in the target area after responding to the trigger operation on the first resource animation (or the non-target area). In some embodiments, the terminal device may alternatively cancel displaying of the first resource animation in the target area when responding to a sliding operation on the first resource animation.

In some embodiments, the terminal device may alternatively display the first resource animation in the target area according to display duration. The display duration may be time for which the first resource animation is continuously displayed in the target area. The display duration of the first resource animation is not limited in embodiments of this application. For example, the display duration of the first resource animation may be 10 s (namely, 10 seconds).

The interaction area may be a group chat interaction area (that is, the sample interaction object and the target interaction object may be interaction objects of a group chat), or may be a customer to customer (C2C) chat interaction area (that is, the sample interaction object and the target interaction object may be interaction objects of a customer to customer chat). This is not limited in embodiments of this application. Correspondingly, the message preview box associated with the interaction object may be a message preview box corresponding to the group chat, or may be a message preview box corresponding to the customer to customer chat. In addition, the target interaction object and the sample interaction object may be in a friendship with each other, or may not be in a friendship with each other (namely, in a non-friendship with each other). This is not limited in embodiments of this application.

In the data processing method provided in embodiments of this application, a message list is displayed in an application interface, the message list including a message preview box associated with an interaction object, and the message preview box including an avatar area and a target area that does not overlap the avatar area; then, a first preview message generated based on a first original interaction message sent by the interaction object is displayed in the message preview box; a first resource animation including a virtual image corresponding to the interaction object is displayed in the target area, the first resource animation being determined based on media content included in the first original interaction message and a media format of the media content; and then in response to a trigger operation on the first resource animation, a message service associated with the first original interaction message is executed. Therefore, when the first original interaction message sent by the interaction object is received, the virtual image corresponding to the interaction object may be obtained, and the first resource animation (namely, the first resource animation associated with the first original interaction message) including the virtual image corresponding to the interaction object is obtained based on the media content included in the first original interaction message and the media format of the media content. When all different interaction objects send first original interaction messages, resource animations respectively corresponding to different interaction objects may be generated based on virtual images respectively corresponding to different interaction objects. Because the virtual images respectively corresponding to different interaction objects are different, the resource animations that respectively correspond to different interaction objects and that are generated based on different virtual images are different, to implement personalized resource animation presentation. In addition, when the media content included in the first original interaction message is different, the first resource animation is different. Therefore, specific content in the first original interaction message may be reflected by using the first resource animation, so that when the first original interaction message is a new message with a high value, the new message with the high value (namely, a new message that needs to be focused on) is highlighted in a manner of the first resource animation, to enrich a new message notification manner. In addition, the message service associated with the first original interaction message may be directly executed in response to the trigger operation on the first resource animation, without entering a chat interface in which the first original interaction message is located, to simplify a procedure of operating the new message, and improve efficiency of processing the new message.

Further, FIG. 5 is a schematic flowchart of a data processing method according to an embodiment of this application. The method may be performed by a server, may be performed by a terminal device, or may be jointly performed by the server and the terminal device. The server may be the server 2000 in the foregoing embodiment corresponding to FIG. 1, and the terminal device may be the sample terminal device or the target terminal device in the foregoing embodiment corresponding to FIG. 1. For ease of understanding, in embodiments of this application, an example in which the method is performed by the terminal device is configured for description. The data processing method may include the following operation S201 to operation S207.

Operation S201: Display a first preview message in a message preview box.

The first preview message is determined based on a first original interaction message sent by an interaction object. For a specific process of displaying the first preview message in the message preview box, reference may be made to the descriptions of operation S102 in the foregoing embodiment corresponding to FIG. 2. Details are not described herein again.

Operation S202: Synchronously display, in a target area of the message preview box, a first resource sub-animation formed by a virtual image corresponding to the interaction object, and display a second resource sub-animation, the second resource sub-animation being generated based on a message virtual resource that may be configured for interacting with the virtual image.

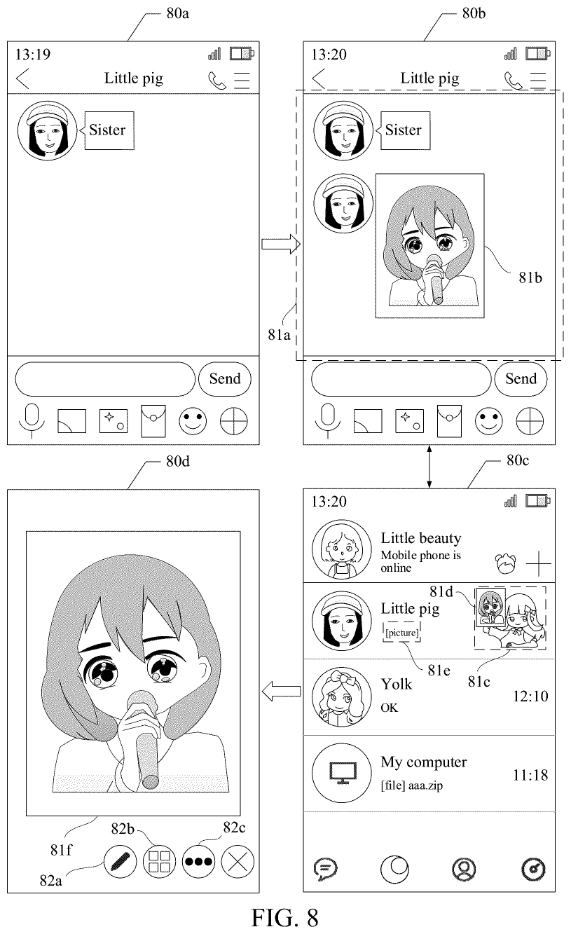

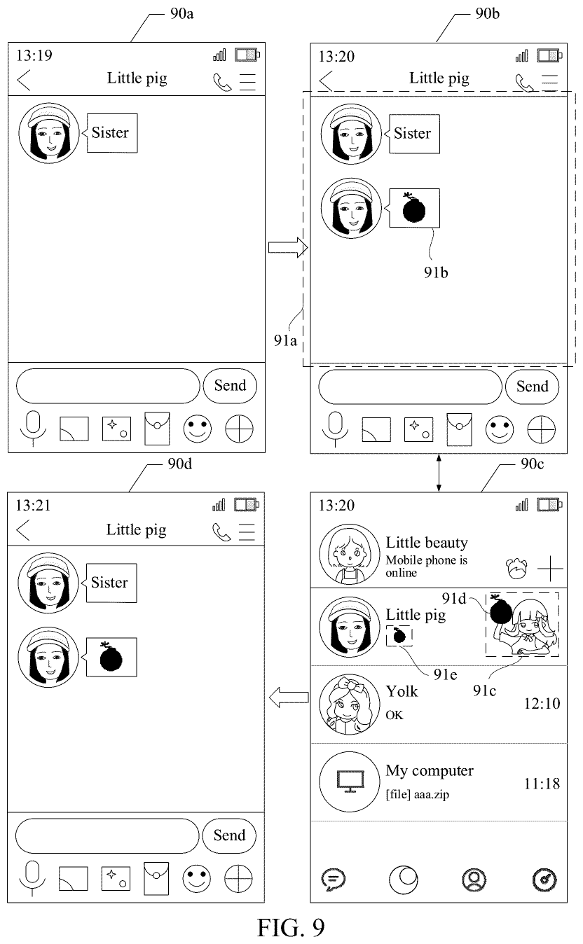

The message virtual resource may include an image message virtual resource. The terminal device may display, in the target area of the message preview box, the first resource sub-animation formed by the virtual image corresponding to the interaction object. Further, if a media format of media content included in the first original interaction message is a media format corresponding to image-type content, the terminal device may determine the media content included in the first original interaction message as the image message virtual resource. Further, the terminal device may display the second resource sub-animation in the target area, and the second resource sub-animation is generated based on the message virtual resource that may be configured for interacting with the virtual image. The media content included in the first original interaction message may include, but is not limited to, image content (reference is made to descriptions of the following embodiment corresponding to FIG. 8) and sticker content (reference is made to descriptions of the following embodiment corresponding to FIG. 9). In other words, the image content and the sticker content may be collectively referred to as the image-type content.

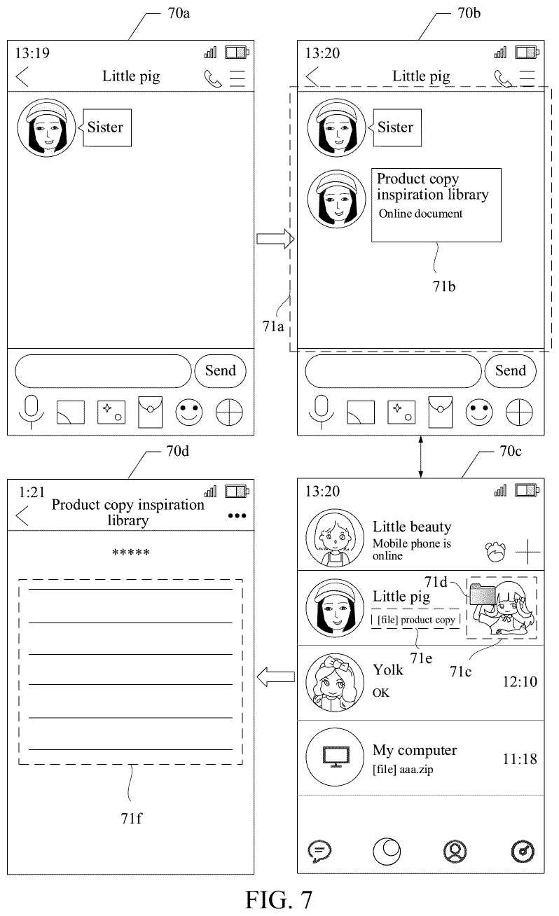

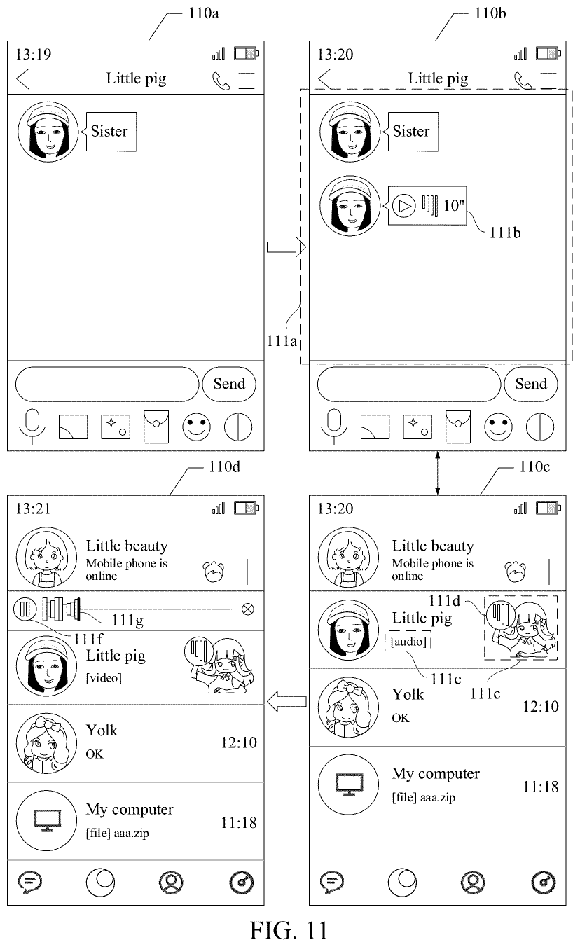

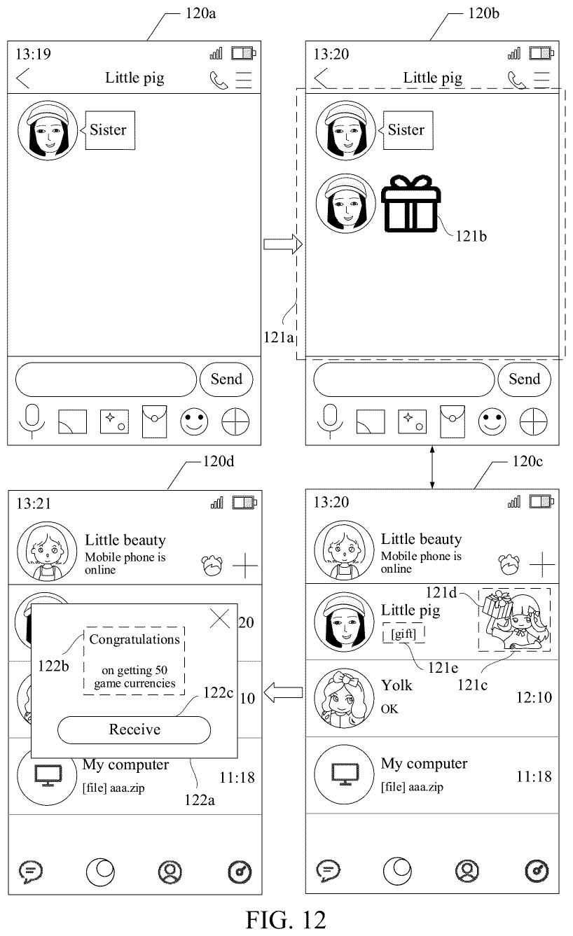

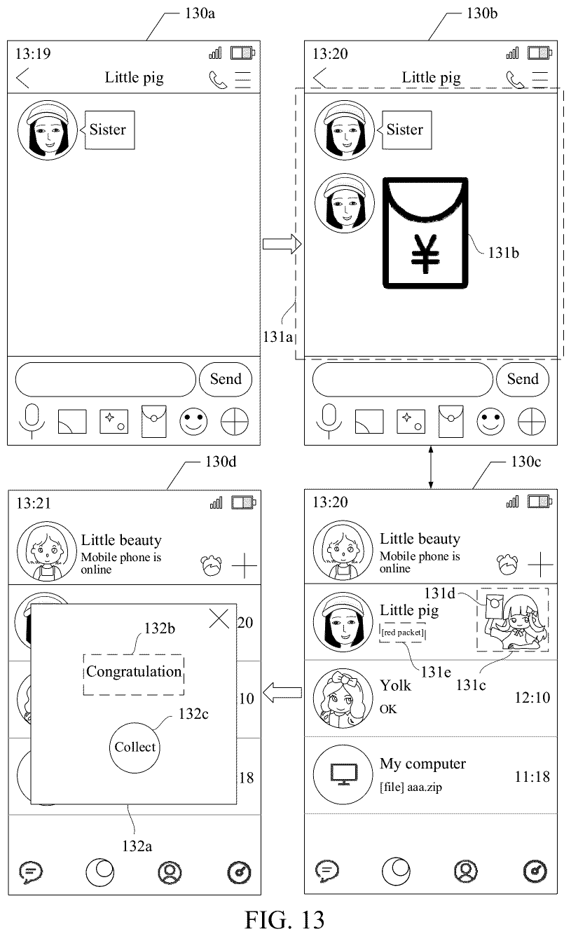

In some embodiments, the message virtual resource may include a file message virtual resource. The terminal device may display, in the target area of the message preview box, the first resource sub-animation formed by the virtual image corresponding to the interaction object. Further, if the media format of the media content included in the first original interaction message is a media format corresponding to file-type content, the terminal device may obtain the file message virtual resource indicated by the media content included in the first original interaction message. Further, the terminal device may display the second resource sub-animation in the target area, and the second resource sub-animation is generated based on the file message virtual resource that may be configured for interacting with the virtual image. The media content included in the first original interaction message may include, but is not limited to, document content (reference is made to descriptions of the following embodiment corresponding to FIG. 7), audio content (reference is made to descriptions of the following embodiment corresponding to FIG. 11), gift content (reference is made to descriptions of the following embodiment corresponding to FIG. 12), red packet content (reference is made to descriptions of the following embodiment corresponding to FIG. 13), and money transfer content. In other words, the document content, the audio content, the gift content, the red packet content, and the money transfer content may be collectively referred to as the file-type content.

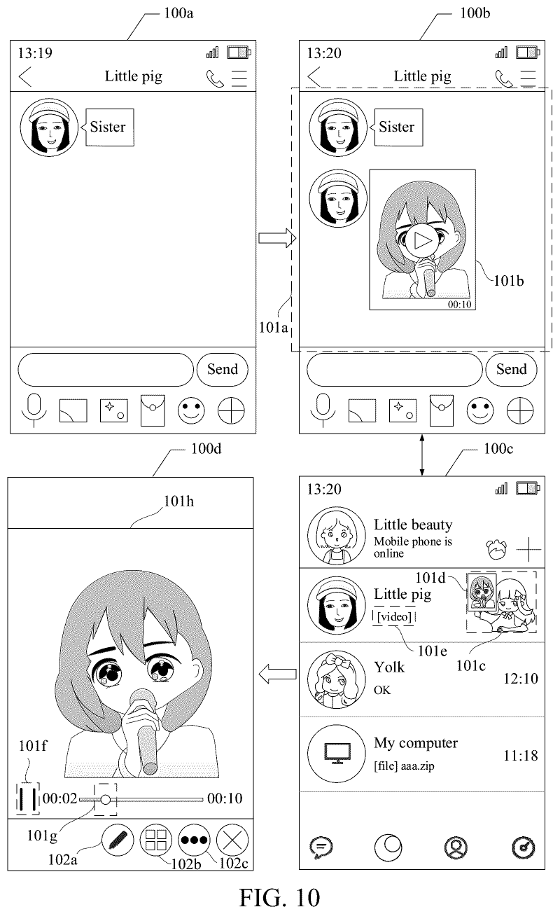

In some embodiments, the message virtual resource may include a video message virtual resource. The terminal device may display, in the target area of the message preview box, the first resource sub-animation formed by the virtual image corresponding to the interaction object. Further, if the media format of the media content included in the first original interaction message is a media format corresponding to video-type content, the terminal device may obtain a preview video frame in the media content included in the first original interaction message, and determine the preview video frame as the video message virtual resource. In some embodiments, the terminal device may obtain the video message virtual resource indicated by the media format of the media content included in the first original interaction message. Further, the terminal device may display the second resource sub-animation in the target area, and the second resource sub-animation is generated based on the video message virtual resource that may be configured for interacting with the virtual image. The media content included in the first original interaction message may include, but is not limited to, video content (reference is made to descriptions of the following embodiment corresponding to FIG. 10). In other words, the video content may be collectively referred to as the video-type content. The video content may be a long video or a short video. This is not limited in this application.

The preview video frame may be a video frame in the video content. That the preview video frame is a specific frame in the video content is not limited in embodiments of this application. For example, the preview video frame may be a 1^{st} video frame in the video content. For another example, the preview video frame may be a last video frame in the video content. For another example, the preview video frame may be a video frame having a highest video score in the video content. In this case, the terminal device may input each video frame in the video content to a video frame scoring model, and output, by using the video frame scoring model, a video score corresponding to each video frame in the video content.

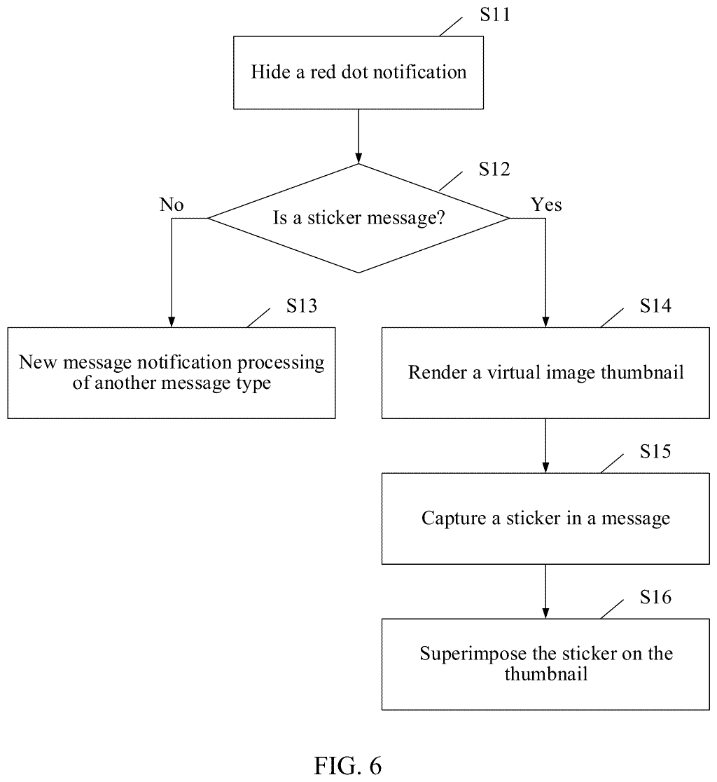

For ease of understanding, for a processing procedure of processing a sticker message (namely, sticker content), reference may be made to FIG. 6. FIG. 6 is a schematic flowchart of processing a sticker message according to an embodiment of this application. For a processing procedure of a message other than the sticker message, reference may be made to descriptions of FIG. 6. As shown in FIG. 6, the terminal device may perform operation S11, and cancel displaying of the preset message resource (for example, the preset message resource may be a red dot (namely, a red circle) that does not include a digit, a red dot (namely, a red circle) including a digit, or the like, and descriptions are provided herein by using an example in which the preset message resource may be the red dot that does not include the digit) in operation S11. Hiding a red dot prompt indicates canceling displaying of the red dot that does not include the digit.

Further, as shown in FIG. 6, the terminal device may perform operation S12, and determine whether the media content included in the first original interaction message is the sticker content in operation S12. If the media content included in the first original interaction message is not the sticker content, operation S13 is performed. If the media content included in the first original interaction message is the sticker content, operation S14 is performed. The terminal device may perform new message notification processing of another message type on the first original interaction message in operation S13, for example, determine whether the media content included in the first original interaction message is image content.

In some embodiments, as shown in FIG. 6, the terminal device may render a thumbnail of the virtual image in operation S14, that is, display the virtual image corresponding to the interaction object. The virtual image may be the thumbnail generated based on the virtual image. Further, the terminal device may perform operation S15, and capture a sticker in a message in operation S15, that is, obtain the media content included in the first original interaction message, and determine the media content included in the first original interaction message as the image message virtual resource. The media content herein may be the sticker content in the first original interaction message, that is, the image message virtual resource may be the sticker content in the first original interaction message. Further, the terminal device may perform operation S16, and superimpose the sticker on the thumbnail in operation S16, that is, superimpose the virtual image (the first resource sub-animation) corresponding to the interaction object and the image message virtual resource (the second resource sub-animation), to obtain the first resource animation.

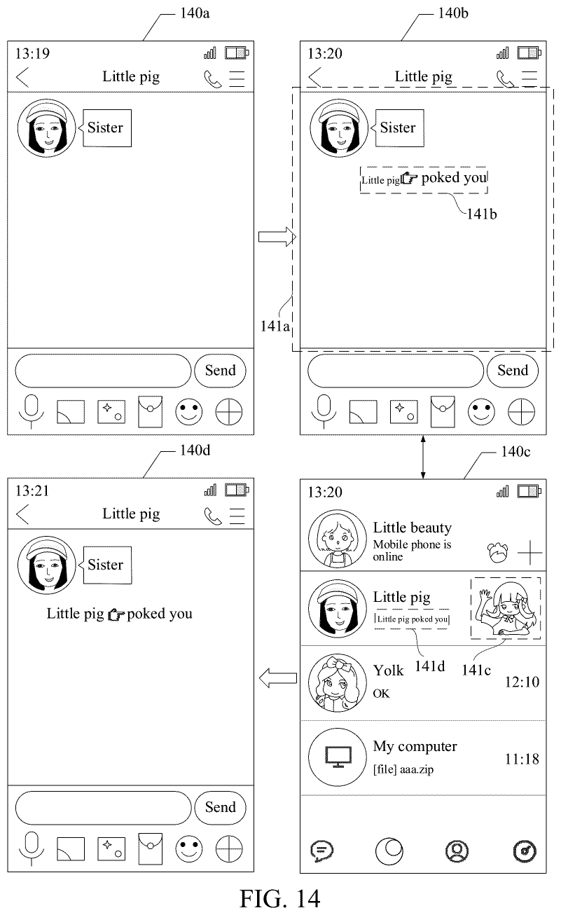

For a specific process in which the terminal device displays the first resource animation, reference may be made to descriptions of the following embodiments corresponding to FIG. 7 to FIG. 14. FIG. 7 to FIG. 14 may represent different first resource animations of which generation is triggered by using different first original interaction messages. The first resource animation may include the first resource sub-animation, or may include the first resource sub-animation and the second resource sub-animation. For a specific process in which the first resource animation includes the first resource sub-animation and the second resource sub-animation, reference may be made to descriptions of the following embodiments corresponding to FIG. 7 to FIG. 13. For a specific process in which the first resource animation includes the first resource sub-animation, reference may be made to descriptions of the following embodiment corresponding to FIG. 14.

For ease of understanding, FIG. 7 is a schematic diagram showing a scenario of processing a document message according to an embodiment of this application. FIG. 7 is a schematic diagram showing a scenario of superimposing document content and a virtual image. An application interface 70a and an application interface 70b shown in FIG. 7 may be application interfaces of the application client in the terminal device at different moments, and an application interface 70c and an application interface 70d shown in FIG. 7 may be application interfaces of the application client in the terminal device at different moments.

As shown in FIG. 7, the terminal device may display the application interface 70a in the application client. If the terminal device receives the first original interaction message (for example, an interaction message 71b) sent by the interaction object, the terminal device may switch the application interface 70a to the application interface 70b, and display the interaction message 71b in an interaction area 71a of the application interface 70b. The interaction message 71b may be document content.

In some embodiments, as shown in FIG. 7, the terminal device may display the application interface 70c in the application client. If the terminal device receives the first original interaction message (for example, the interaction message 71b) sent by the interaction object, the terminal device may display the first resource animation (for example, a resource animation 71c) in the target area of the message preview box associated with the interaction object, and display the first preview message (for example, a preview message 71e) in the message preview box associated with the interaction object. The resource animation 71c may include a file message virtual resource 71d corresponding to the document content, and the preview message 71e may include preview content “[file] product copy” corresponding to the document content, and the “product copy” may belong to a document title of the document content. The document content in embodiments of this application may include, but is not limited to, a word document, an excel document, and a txt document. In embodiments of this application, different file message virtual resources may be further respectively generated for the word document, the excel document, and the txt document.

For ease of understanding, FIG. 8 is a schematic diagram showing a scenario of processing a picture message according to an embodiment of this application. FIG. 8 is a schematic diagram showing a scenario of superimposing image content and a virtual image. An application interface 80a and an application interface 80b shown in FIG. 8 may be application interfaces of the application client in the terminal device at different moments, and an application interface 80c and an application interface 80d shown in FIG. 8 may be application interfaces of the application client in the terminal device at different moments.

As shown in FIG. 8, the terminal device may display the application interface 80a in the application client. If the terminal device receives the first original interaction message (for example, an interaction message 81b) sent by the interaction object, the terminal device may switch the application interface 80a to the application interface 80b, and display the interaction message 81b in an interaction area 81a of the application interface 80b. The interaction message 81b may be image content.

In some embodiments, as shown in FIG. 8, the terminal device may display the application interface 80c in the application client. If the terminal device receives the first original interaction message (for example, the interaction message 81b) sent by the interaction object, the terminal device may display the first resource animation (for example, a resource animation 81c) in the target area of the message preview box associated with the interaction object, and display the first preview message (for example, a preview message 81e) in the message preview box associated with the interaction object. The resource animation 81c may include an image message virtual resource 81d corresponding to the image content, and the preview message 81e may include preview content “[picture]” corresponding to the image content.

For ease of understanding, FIG. 9 is a schematic diagram showing a scenario of processing a sticker message according to an embodiment of this application. FIG. 9 is a schematic diagram showing a scenario of superimposing sticker content and a virtual image. An application interface 90a and an application interface 90b shown in FIG. 9 may be application interfaces of the application client in the terminal device at different moments, and an application interface 90c and an application interface 90d shown in FIG. 9 may be application interfaces of the application client in the terminal device at different moments.

As shown in FIG. 9, the terminal device may display the application interface 90a in the application client. If the terminal device receives the first original interaction message (for example, an interaction message 91b) sent by the interaction object, the terminal device may switch the application interface 90a to the application interface 90b, and display the interaction message 91b in an interaction area 91a of the application interface 90b. The interaction message 91b may be sticker content “Bomb.”

In some embodiments, as shown in FIG. 9, the terminal device may display the application interface 90c in the application client. If the terminal device receives the first original interaction message (for example, the interaction message 91b) sent by the interaction object, the terminal device may display the first resource animation (for example, a resource animation 91c) in the target area of the message preview box associated with the interaction object, and display the first preview message (for example, a preview message 91e) in the message preview box associated with the interaction object. The resource animation 91c may include an image message virtual resource 91d corresponding to the sticker content, and the preview message 91e may include preview content “Bomb” corresponding to the sticker content.

For ease of understanding, FIG. 10 is a schematic diagram showing a scenario of processing a video message according to an embodiment of this application. FIG. 10 is a schematic diagram showing a scenario of superimposing video content and a virtual image. An application interface 100a and an application interface 100b shown in FIG. 10 may be application interfaces of the application client in the terminal device at different moments, and an application interface 100c and an application interface 100d shown in FIG. 10 may be application interfaces of the application client in the terminal device at different moments.

As shown in FIG. 10, the terminal device may display the application interface 100a in the application client. If the terminal device receives the first original interaction message (for example, an interaction message 101b) sent by the interaction object, the terminal device may switch the application interface 100a to the application interface 100b, and display the interaction message 101b in an interaction area 101a of the application interface 100b. The interaction message 101b may be video content.

In some embodiments, as shown in FIG. 10, the terminal device may display the application interface 100c in the application client. If the terminal device receives the first original interaction message (for example, the interaction message 101b) sent by the interaction object, the terminal device may display the first resource animation (for example, a resource animation 101c) in the target area of the message preview box associated with the interaction object, and display the first preview message (for example, a preview message 101e) in the message preview box associated with the interaction object. The resource animation 101c may include a video message virtual resource 101d corresponding to the video content, and the preview message 101e may include preview content “[video]” corresponding to the video content.

For ease of understanding, FIG. 11 is a schematic diagram showing a scenario of processing an audio message according to an embodiment of this application. FIG. 11 is a schematic diagram showing a scenario of superimposing audio content and a virtual image. An application interface 110a and an application interface 110b shown in FIG. 11 may be application interfaces of the application client in the terminal device at different moments, and an application interface 110c and an application interface 110d shown in FIG. 11 may be application interfaces of the application client in the terminal device at different moments.

As shown in FIG. 11, the terminal device may display the application interface 110a in the application client. If the terminal device receives the first original interaction message (for example, an interaction message 111b) sent by the interaction object, the terminal device may switch the application interface 110a to the application interface 110b, and display the interaction message 111b in an interaction area 111a of the application interface 110b. The interaction message 111b may be audio content.

In some embodiments, as shown in FIG. 11, the terminal device may display the application interface 110c in the application client. If the terminal device receives the first original interaction message (for example, the interaction message 111b) sent by the interaction object, the terminal device may display the first resource animation (for example, a resource animation 111c) in the target area of the message preview box associated with the interaction object, and display the first preview message (for example, a preview message 111e) in the message preview box associated with the interaction object. The resource animation 111c may include a file message virtual resource 111d corresponding to the audio content, and the preview message 111e may include preview content “[audio]” corresponding to the audio content.

For ease of understanding, FIG. 12 is a schematic diagram showing a scenario of processing a gift message according to an embodiment of this application. FIG. 12 is a schematic diagram showing a scenario of superimposing gift content and a virtual image. An application interface 120a and an application interface 120b shown in FIG. 12 may be application interfaces of the application client in the terminal device at different moments, and an application interface 120c and an application interface 120d shown in FIG. 12 may be application interfaces of the application client in the terminal device at different moments.

As shown in FIG. 12, the terminal device may display the application interface 120a in the application client. If the terminal device receives the first original interaction message (for example, an interaction message 121b) sent by the interaction object, the terminal device may switch the application interface 120a to the application interface 120b, and display the interaction message 121b in an interaction area 121a of the application interface 120b. The interaction message 121b may be gift content.

In some embodiments, as shown in FIG. 12, the terminal device may display the application interface 120c in the application client. If the terminal device receives the first original interaction message (for example, the interaction message 121b) sent by the interaction object, the terminal device may display the first resource animation (for example, a resource animation 121c) in the target area of the message preview box associated with the interaction object, and display the first preview message (for example, a preview message 121e) in the message preview box associated with the interaction object. The resource animation 121c may include a file message virtual resource 121d corresponding to the gift content, and the preview message 121e may include preview content “[gift]” corresponding to the gift content.

For ease of understanding, FIG. 13 is a schematic diagram showing a scenario of processing a red packet message according to an embodiment of this application. FIG. 13 is a schematic diagram showing a scenario of superimposing red packet content and a virtual image. An application interface 130a and an application interface 130b shown in FIG. 13 may be application interfaces of the application client in the terminal device at different moments, and an application interface 130c and an application interface 130d shown in FIG. 13 may be application interfaces of the application client in the terminal device at different moments.

As shown in FIG. 13, the terminal device may display the application interface 130a in the application client. If the terminal device receives the first original interaction message (for example, an interaction message 131b) sent by the interaction object, the terminal device may switch the application interface 130a to the application interface 130b, and display the interaction message 131b in an interaction area 131a of the application interface 130b. The interaction message 131b may be red packet content.

In some embodiments, as shown in FIG. 13, the terminal device may display the application interface 130c in the application client. If the terminal device receives the first original interaction message (for example, the interaction message 131b) sent by the interaction object, the terminal device may display the first resource animation (for example, a resource animation 131c) in the target area of the message preview box associated with the interaction object, and display the first preview message (for example, a preview message 131e) in the message preview box associated with the interaction object. The resource animation 131c may include a file message virtual resource 131d corresponding to the red packet content, and the preview message 131e may include preview content “[red packet]” corresponding to the red packet content.

The first original interaction message may further include media content in a plurality of media formats, that is, the first original interaction message may include at least two pieces of media content of the text content, the image content, the sticker content, the document content, the red packet content, the gift content, the money transfer content, the audio content, and the video content. In this case, the terminal device may determine the displayed first resource sub-animation and second resource sub-animation based on the media content that is included in the first original interaction message and that is in the plurality of media formats. For example, the first original interaction message may include the text content and the sticker content (for example, the first original interaction message may be “Throw you a bomb [bomb],” where “[bomb]” may represent a sticker in a style of “bomb”). For another example, the first original interaction message may include the text content and the image content (for example, the first original interaction message may be “Look at my dancing photo [picture],” where “[picture]” may be a picture). For another example, the first original interaction message may include the text content and the sticker content (for example, the first original interaction message may be “Throw you a bomb [bomb] [heart],” where “[bomb]” may represent a sticker in a style of “bomb,” and “[heart]” may represent a sticker in a style of “heart”). In this case, the second resource sub-animation may be determined by using a 1^{st} piece of media content (namely, “[bomb],” and in this case, the second resource sub-animation may include a message virtual resource in a style of “[bomb]”) that is in the first original interaction message and that can trigger generation of the message virtual resource, or determined by using all media content (namely, “[bomb]” and “[heart],” and in this case, the second resource sub-animation may include a message virtual resource in a style of “[bomb]” and a message virtual resource in a style of “[heart]”) that is in the first original interaction message and that can trigger generation of the message virtual resources.

Operation S203: Display, in the target area of the message preview box, the first resource sub-animation formed by the virtual image corresponding to the interaction object.

If the media format of the media content included in the first original interaction message is a media format corresponding to interaction content, the terminal device may not need to display the second resource sub-animation in the target area, where the second resource sub-animation is generated based on the message virtual resource that may be configured for interacting with the virtual image, but directly display, in the target area of the message preview box, the first resource sub-animation formed by the virtual image corresponding to the interaction object. The interaction content may include, but is not limited to, poke content, shake content, and tickle content.

For ease of understanding, FIG. 14 is a schematic diagram showing a scenario of processing a poke message according to an embodiment of this application. An application interface 140a and an application interface 140b shown in FIG. 14 may be application interfaces of the application client in the terminal device at different moments, and an application interface 140c and an application interface 140d shown in FIG. 14 may be application interfaces of the application client in the terminal device at different moments.

As shown in FIG. 14, the terminal device may display the application interface 140a in the application client. If the terminal device receives the first original interaction message (for example, an interaction message 141b) sent by the interaction object, the terminal device may switch the application interface 140a to the application interface 140b, and display the interaction message 141b in an interaction area 141a of the application interface 140b. The interaction message 141b may be poke content (shake content, tickle content, or the like), and the interaction message 141b may not be configured for triggering generation of the second resource sub-animation.

In some embodiments, as shown in FIG. 14, the terminal device may display the application interface 140c in the application client. If the terminal device receives the first original interaction message (for example, the interaction message 141b) sent by the interaction object, the terminal device may display the first resource animation (for example, a resource animation 141c) in the target area of the message preview box associated with the interaction object, and display the first preview message (for example, a preview message 141d) in the message preview box associated with the interaction object. The preview message 141d may include preview content “Little pig poked you” corresponding to the poke content (preview content “Little pig shook you” corresponding to the shake content, or preview content “Little pig tickled you” corresponding to the tickle content).

In the foregoing embodiments corresponding to FIG. 7 to FIG. 14, first resource sub-animations corresponding to different first original interaction messages are the same. For example, the first resource sub-animation may be an action of raising a hand by the virtual image. Actually, first resource sub-animations corresponding to different first original interaction messages may alternatively be different. An example in which the first resource sub-animations corresponding to different first original interaction messages are the same is used herein for description.

Operation S204: Determine a resource animation type of the first resource animation.

The resource animation type of the first resource animation may be a resource animation type corresponding to a triggerable resource animation or a resource animation type corresponding to an untriggerable resource animation. If the resource animation type of the first resource animation is the resource animation type corresponding to the triggerable resource animation (that is, the first resource animation is the triggerable resource animation), the terminal device may perform the following operation S205. In some embodiments, if the resource animation type of the first resource animation is the resource animation type corresponding to the untriggerable resource animation (that is, the first resource animation is the untriggerable resource animation), the terminal device may perform the following operation S206 and operation S207.

Operation S205: If the first resource animation is a triggerable resource animation, display, in response to a trigger operation on the first resource animation, media data associated with media content that is in the first original interaction message and that is in a triggerable media format.

The first resource animation may include a viewing message virtual resource. If the first resource animation is the triggerable resource animation, the terminal device may switch the application interface to a viewing interface in response to the trigger operation on the first resource animation (namely, in response to a trigger operation on the virtual image in the first resource animation or in response to a trigger operation on the message virtual resource in the first resource animation). The trigger operation on the first resource animation is a trigger operation for viewing the virtual image in the first resource animation or a trigger operation for viewing the message virtual resource in the first resource animation. Further, the terminal device may display, in the viewing interface, media data associated with media content that is in the first original interaction message and that is in a viewing media format, The viewing media format is a triggerable media format indicated by the viewing message virtual resource, and the viewing media format may be a media format corresponding to the document content, a media format corresponding to the picture content, or a media format corresponding to the video content.

In an embodiment, the triggerable resource animation means that viewing of a virtual image in a resource animation can be triggered by using an operation, or viewing of a message virtual resource in the resource animation can be triggered by using an operation. The untriggerable resource animation means that viewing of a virtual image in a resource animation cannot be triggered by using an operation, or viewing of a message virtual resource in the resource animation cannot be triggered by using an operation.

For ease of understanding, reference is made to FIG. 7 again. The terminal device may switch the application interface 70c to the application interface 70d (or a viewing interface 70d) in response to a trigger operation on the resource animation 71c (for example, the terminal device may respond to a trigger operation on the file message virtual resource 71d (namely, a viewing message virtual resource 71d) in the resource animation 71c), and display, in the application interface 70d, media data associated with media content that is in the interaction message 71b and that is in a viewing media format, that is, display, in the application interface 70d, media data associated with the document content. For example, the media data associated with the document content may be a text 71f, an image, a table, or the like in the document content.

For ease of understanding, reference is made to FIG. 8 again. The terminal device may switch the application interface 80c to the application interface 80d (or a viewing interface 80d) in response to a trigger operation on the resource animation 81c (for example, the terminal device may respond to a trigger operation on the image message virtual resource 81d (namely, a viewing message virtual resource 81d) in the resource animation 81c), and display, in the application interface 80d, media data associated with media content that is in the interaction message 81b and that is in a viewing media format, that is, display, in the application interface 80d, media data associated with the image content. For example, the media data associated with the image content may be image content 81f, a parameter of a camera for shooting the image content, a size of the image content, an image editing control 82a, an image viewing control 82b, an image sharing control 82c, or the like. The image editing control 82a may be configured to edit the image content 81f (for example, cut the image content 81f). The image viewing control 82b may be configured to view historical image content from which communication is performed with the interaction object, where the historical image content may include the image content 81f. The image sharing control 82c may be configured to share the image content 81f. In some embodiments, the image viewing control 82b may be configured to view historical video content and historical image content from which communication is performed with the interaction object.

For ease of understanding, reference is made to FIG. 10 again. The terminal device may switch the application interface 100c to the application interface 100d (or a viewing interface 100d) in response to a trigger operation on the resource animation 101c (for example, the terminal device may respond to a trigger operation on the video message virtual resource 101d (namely, a viewing message virtual resource 101d) in the resource animation 101c), and display, in the application interface 100d, media data associated with media content that is in the interaction message 101b and that is in a viewing media format, that is, display, in the application interface 100d, media data associated with the video content. For example, the media data associated with the video content may be a video frame 101h in the video content, a video play progress controlling control 101g, a video play controlling control 101f, a video editing control 102a, a video viewing control 102b, a video sharing control 102c, or the like. The video play controlling control 101f may be configured to control playing or pausing of the video content. The video play progress controlling control 101g may be configured to control a play progress of the video content. The video play progress controlling control 101g may be configured to perform dragging. The video editing control 102a may be configured to edit the video content (for example, capture a video frame in the video content). The video viewing control 102b may be configured to view historical video content from which communication is performed with the interaction object, where the historical video content may include video content to which the video frame 101h belongs. The video sharing control 102c may be configured to share the video content to which the video frame 101h belongs. In some embodiments, the video viewing control 102b may be configured to view historical video content and historical image content from which communication is performed with the interaction object.

In some embodiments, the first resource animation may include an audio message virtual resource. If the first resource animation is the triggerable resource animation, the terminal device may display, in response to the trigger operation on the first resource animation (namely, in response to a trigger operation on the virtual image in the first resource animation or in response to a trigger operation on the message virtual resource in the first resource animation), a play progress corresponding to media content that is in the first original interaction message and that is in an audio media format. The audio media format is a triggerable media format indicated by the audio message virtual resource. Further, the terminal device may play, in response to a dragging operation on the play progress, the media content in the audio media format according to a dragged play progress. The audio media format may be a media format corresponding to the audio content.

For ease of understanding, reference is made to FIG. 11 again. The terminal device may switch the application interface 110c to the application interface 110d in response to a trigger operation on the resource animation 111c (for example, the terminal device may respond to a trigger operation on the file message virtual resource 111d (namely, an audio message virtual resource 111d) in the resource animation 111c), and display, in the application interface 110d, a play progress corresponding to media content that is in the interaction message 111b and that is in an audio media format, that is, display, in the application interface 110d, a play progress corresponding to the audio content. For example, the play progress corresponding to the audio content may include an audio play progress controlling control 111g, an audio play controlling control 111f, and the like. The audio play controlling control 111f may be configured to control playing or pausing of the audio content. The audio play progress controlling control 111g may be configured to control a play progress of the audio content, and the audio play progress controlling control 111g may be configured to perform dragging.

In some embodiments, the first resource animation may include a collection message virtual resource. If the first resource animation is the triggerable resource animation, the terminal device may display, in response to the trigger operation on the first resource animation (namely, in response to a trigger operation on the virtual image in the first resource animation or in response to a trigger operation on the message virtual resource in the first resource animation), resource description information and a resource collection control that correspond to media content that is in the first original interaction message and that is in a collection media format. The collection media format is a triggerable media format indicated by the collection message virtual resource, and the collection media format may be a media format corresponding to the red packet content, a media format corresponding to the gift content, or a media format corresponding to the money transfer content. Further, the terminal device may collect, in response to a trigger operation on the resource collection control, an animation virtual resource indicated by the resource description information.

For ease of understanding, reference is made to FIG. 12 again. The terminal device may switch the application interface 120c to the application interface 120d in response to a trigger operation on the resource animation 121c (for example, the terminal device may respond to a trigger operation on the file message virtual resource 121d (namely, a collection message virtual resource 121d) in the resource animation 121c), display, in the application interface 120d, a resource collection area 122a corresponding to media content that is in the interaction message 121b and that is in a collection media format, and display resource description information 122b and a resource collection control 122c in the resource collection area 122a, that is, display, in the application interface 120d, the resource description information 122b and the resource collection control 122c that correspond to the gift content. Further, the terminal device may collect, in response to a trigger operation on the resource collection control 122c, an animation virtual resource indicated by the resource description information 122b, where the animation virtual resource herein may be “50 game currencies.”

For ease of understanding, reference is made to FIG. 13 again. The terminal device may switch the application interface 130c to the application interface 130d in response to a trigger operation on the resource animation 131c (for example, the terminal device may respond to a trigger operation on the file message virtual resource 131d (namely, a collection message virtual resource 131d) in the resource animation 131c), display, in the application interface 130c, a resource collection area 132a corresponding to media content that is in the interaction message 131b and that is in a collection media format, and display resource description information 132b and a resource collection control 132c in the resource collection area 132a, that is, display, in the application interface 130d, the resource description information 132b and the resource collection control 132c that correspond to the gift content. Further, the terminal device may collect, in response to a trigger operation on the resource collection control 132c, an animation virtual resource indicated by the resource description information 132b.

Operation S206: If the first resource animation is an untriggerable resource animation, display, in response to the trigger operation on the first resource animation, the interaction area associated with the interaction object.

Operation S207: Display the first original interaction message in the interaction area.

For ease of understanding, reference is made to FIG. 9 again. The terminal device may switch the application interface 90c to the application interface 90d in response to a trigger operation on the resource animation 91c (for example, the terminal device may respond to a trigger operation on the image message virtual resource 91d in the resource animation 91c), and display the interaction message 91b in an interaction area of the application interface 90d.

For ease of understanding, reference is made to FIG. 14 again. The terminal device may switch the application interface 140c to the application interface 140d in response to a trigger operation on the resource animation 141c (for example, the terminal device may respond to a trigger operation on the virtual image in the resource animation 141c), and display the interaction message 141b in an interaction area of the application interface 140d.

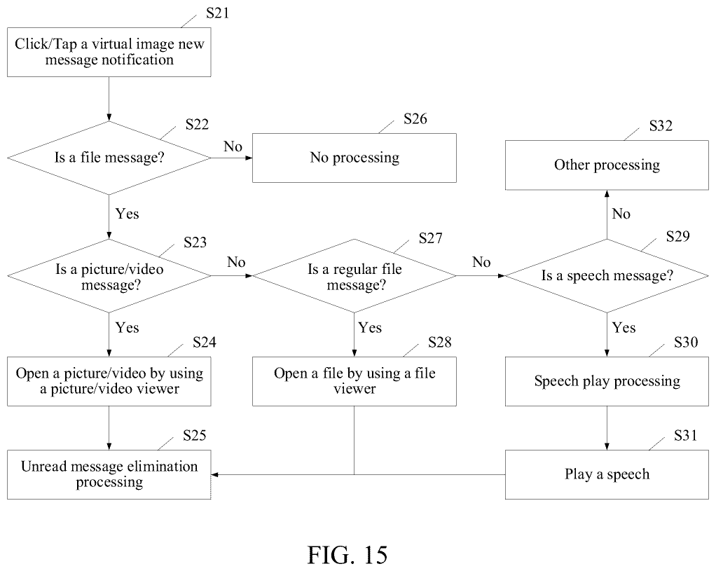

For ease of understanding, FIG. 15 is a schematic diagram showing a scenario of triggering a first resource animation according to an embodiment of this application. As shown in FIG. 15, the terminal device may perform operation S21, and respond to, in operation S21, clicking/tapping a virtual image new message notification performed by a sample interaction object, that is, the terminal device may respond to a trigger operation on a first resource animation. Further, the terminal device may perform operation S22, and determine whether a first original interaction message is a file-type message in operation S22. The file-type message herein may be an interaction message including document content, picture content, video content, audio content, gift content, or red packet content.

Further, as shown in FIG. 15, if the first original interaction message is not the file-type message (that is, the first original interaction message does not include the document content, the picture content, the video content, the audio content, the gift content, or the red packet content), the terminal device may perform operation S26, and does not need to perform resource animation processing in operation S26. In some embodiments, if the first original interaction message is the file-type message (that is, the first original interaction message includes the document content, the picture content, the video content, the audio content, the gift content, or the red packet content), the terminal device may perform operation S23, and determine whether the first original interaction message is a picture message or a video message in operation S23.

Further, as shown in FIG. 15, if the first original interaction message is the picture message or the video message (that is, the first original interaction message includes the picture content or the video content), the terminal device may perform operation S24, and open the picture content or the video content in the first original interaction message in operation S24. In operation S24, the picture content in the first original interaction message may be opened by using a picture viewer, and the video content in the first original interaction message may be opened by using a video viewer. Further, the terminal device may perform operation S25, and perform unread message elimination processing in operation S25, that is, cancel displaying of the first resource animation in a target area.

In some embodiments, as shown in FIG. 15, if the first original interaction message is not the picture message or the video message (that is, the first original interaction message does not include the picture content or the video content), the terminal device may perform operation S27, and determine whether the first original interaction message is a regular file message in operation S27, where the regular file message herein may be an interaction message including the document content.

Further, as shown in FIG. 15, if the first original interaction message is the regular file message (that is, the first original interaction message includes the document content), the terminal device may perform operation S28, and open a file (namely, the document content) in the first original interaction message in operation S28. In operation S28, the document content in the first original interaction message may be opened by using a file viewer. Further, the terminal device may perform operation S25, and perform unread message elimination processing in operation S25, that is, cancel displaying of the first resource animation in the target area.

In some embodiments, as shown in FIG. 15, if the first original interaction message is not the regular file message (that is, the first original interaction message does not include the document content), the terminal device may perform operation S29, and determine whether the first original interaction message is a speech message in operation S29, where the speech message herein may be an interaction message including speech content.

Further, as shown in FIG. 15, if the first original interaction message is the speech message (that is, the first original interaction message includes the speech content), the terminal device may perform operation S30, perform speech play processing in operation S30, then perform operation S31, and play the speech content in the first original interaction message in operation S31. Further, the terminal device may perform operation S25, and perform unread message elimination processing in operation S25, that is, cancel displaying of the first resource animation in the target area.

In some embodiments, as shown in FIG. 15, if the first original interaction message is not the speech message (that is, the first original interaction message does not include the speech content), the terminal device may perform operation S32, and perform other processing in operation S32. For example, in operation S32, it may be determined whether the first original interaction message is an interaction message (that is, whether the first original interaction message includes the red packet content or the gift content).

It can be learned that, in embodiments of this application, after the first original interaction message sent by the interaction object is received, the first resource sub-animation may be displayed in the target area of the message preview box according to the media content included in the first original interaction message and the media format of the media content, or the first resource sub-animation and the second resource sub-animation may be synchronously displayed. Therefore, in embodiments of this application, different resource animations may be displayed according to different media content included in the first original interaction message, different media formats of the media content, and different virtual images respectively corresponding to different interaction objects, to implement a new message notification based on a resource animation, enrich a new message notification manner, and improve interest of receiving a new message. Further, because the first resource animation may have different resource animation types, when responding to the trigger operation on the first resource animation having different resource animation types, the terminal device may execute different message services. The message service may be displaying the media data associated with the media content that is in the first original interaction message and that is in the viewing media format. The message service may alternatively be displaying the interaction area associated with the interaction object, and then displaying the first original interaction message in the interaction area, to improve efficiency of processing a new message based on different message services.

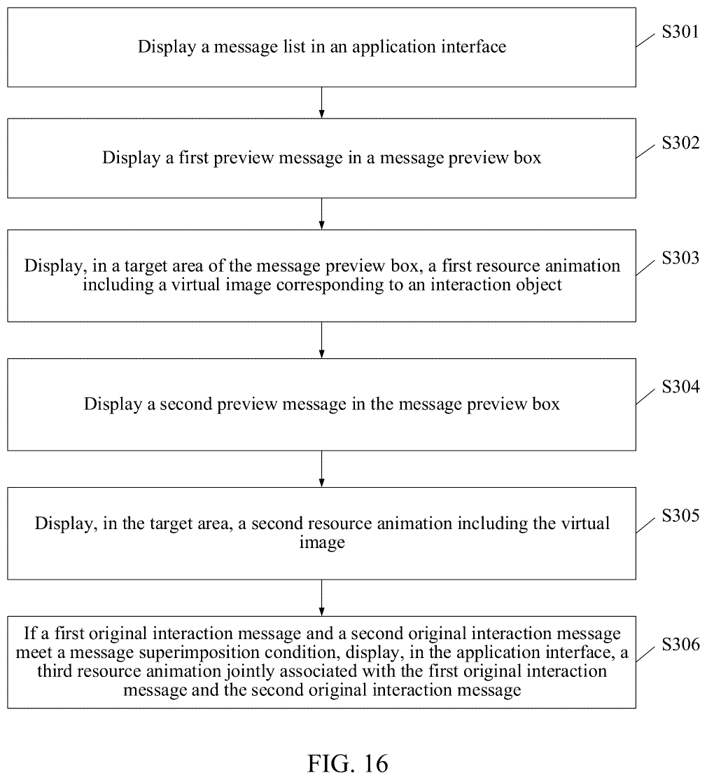

Further, FIG. 16 is a schematic flowchart of a data processing method according to an embodiment of this application. The method may be performed by a server, may be performed by a terminal device, or may be jointly performed by the server and the terminal device. The server may be the server 2000 in the foregoing embodiment corresponding to FIG. 1, and the terminal device may be the sample terminal device or the target terminal device in the foregoing embodiment corresponding to FIG. 1. For ease of understanding, in embodiments of this application, an example in which the method is performed by the terminal device is configured for description. The data processing method may include the following operation S301 to operation S306.

Operation S301: Display a message list in an application interface.

The message list includes a message preview box associated with an interaction object. For example, for the message list, reference may be made to the application interface 70c in the foregoing embodiment corresponding to FIG. 7. The application interface 70c may include the message preview box associated with the interaction object (namely, “Little pig”), and the preview message 71e may be displayed in the message preview box associated with “Little pig.”

Operation S302: Display a first preview message in the message preview box.

Specifically, the terminal device may obtain a quantity of unread messages and a latest message body that are for the interaction object from a message management database according to an object identifier of the interaction object. Further, the terminal device may perform accumulation processing on the quantity of unread messages according to a first original interaction message, to obtain an updated quantity of unread messages, that is, determine a sum of a first default message quantity (namely, 1) and the quantity of unread messages as the updated quantity of unread messages. The terminal device may update the latest message body according to the first original interaction message, to obtain an updated latest message body, that is, determine the first original interaction message as the updated latest message body. Further, the terminal device may display, based on the updated quantity of unread messages and the updated latest message body, the first preview message corresponding to the first original interaction message in the message preview box. The first preview message is generated based on the first original interaction message sent by the interaction object.

Further, when responding to a trigger operation on a first resource animation, the terminal device may zero out the updated quantity of unread messages to obtain an initialized quantity of unread messages, that is, determine a second default message quantity (namely, 0) as the initialized quantity of unread messages. The terminal device may initialize the updated latest message body, to obtain an initialized latest message body, that is, the initialized latest message body is empty. Further, the terminal device may cancel displaying of the first resource animation in a target area based on the initialized quantity of unread messages and the initialized latest message body.

Similarly, when responding to a trigger operation on a non-target area in the message preview box, the terminal device may also zero out the updated quantity of unread messages and initialize the updated latest message body. In this way, when exiting an interaction area associated with the interaction object and returning to the application interface in which the message list is located, the terminal device does not continue to display the first resource animation in the target area of the message preview box.

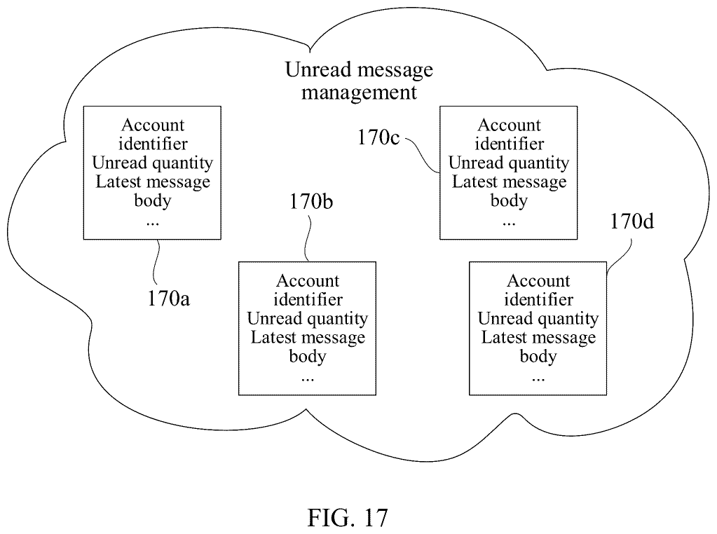

For ease of understanding, FIG. 17 is a schematic diagram showing a scenario of a message management database according to an embodiment of this application. As shown in FIG. 17, the terminal device may include a message management database. The message management database may perform data processing by using an unread message management component. The message management database may store message items respectively corresponding to different interaction objects. For example, the message management database may be configured to store a message item 170a, a message item 170b, a message item 170c, . . . , and a message item 170d. Herein, an example in which the message item 170a is a message item corresponding to a target interaction object is configured for description.

A message item shown in FIG. 17 may include an account identifier, an unread quantity, and a latest message body. The account identifier, the unread quantity, and the latest message body may be stored by using a map structure, a key may be the account identifier, and a value may be the unread quantity and the latest message body. For example, an account identifier in the message item 170a may represent an object identifier (the object identifier is unique) of the target interaction object, an unread quantity in the message item 170a may represent a quantity of unread messages for the target interaction object, and a latest message body in the message item 170a may represent a latest message body for the target interaction object. Therefore, when receiving a first original interaction message sent by the target interaction object, responding to the trigger operation on the first resource animation, and responding to the trigger operation on the non-target area, the terminal device may update the unread quantity and the latest message body in the message item 170a.

In embodiments of this application, a message in which a chat interface (for example, the application interface 70b in the embodiment corresponding to FIG. 7) is not opened for reading may be collectively summarized as a new message. Therefore, when receiving the new message (for example, the first original interaction message), the terminal device may determine the first original interaction message. If the first original interaction message is unread (that is, the terminal device is not currently in the chat interface), the message management database is updated by using an unread message manager (namely, the unread message management component). The unread message manager is a singleton (there is only one object in a singleton mode in an entire system, that is, a message item in the message management database is unique for a same interaction object). The unread message manager may manage an unread quantity corresponding to each interaction object and a latest message body corresponding to each interaction object, so as to perform subsequent service processing.

Operation S303: Display, in a target area of the message preview box, a first resource animation including a virtual image corresponding to the interaction object.

Specifically, the terminal device may display a preset message resource in the target area of the message preview box. Further, if the first resource animation including the virtual image corresponding to the interaction object does not exist in a memory of a terminal, the terminal device may obtain the first resource animation from a server according to the object identifier of the interaction object. Further, the terminal device may update the preset message resource in the target area based on the first resource animation. At the same time, the terminal device may store the first resource animation obtained from the server in the memory of the terminal, to avoid a plurality of requests for downloading. The target area does not overlap an avatar area in the message preview box. The first resource animation is determined based on media content included in the first original interaction message and a media format of the media content.

In some embodiments, if the first resource animation including the virtual image corresponding to the interaction object exists in the memory of the terminal, the terminal device may update the preset message resource in the target area based on the first resource animation in the memory of the terminal. The first resource animation in the memory of the terminal needs to satisfy a valid period (for example, 7 days). If the first resource animation in the memory of the terminal is within the valid period, the terminal device may display the first resource animation in the memory of the terminal. In some embodiments, if the first resource animation in the memory of the terminal is not within the valid period, the terminal device needs to obtain a new first resource animation from the server again, and then displays the obtained new first resource animation. The first resource animation in the memory of the terminal and the new first resource animation obtained from the server may be the same or may be different. If the interaction object does not update the virtual image within the valid period, the first resource animation in the memory of the terminal may be the same as the new first resource animation obtained from the server. If the interaction object updates the virtual image within the valid period, the first resource animation in the memory of the terminal may be different from the new first resource animation obtained from the server.

When storing the first resource animation obtained from the server in the memory of the terminal, the terminal device may store a current time point (for example, a moment T₁) together with the first resource animation. In this way, the terminal device may determine a time interval between a sending time point (for example, a moment T₂) of the first original interaction message and the moment T₁ as an interval period. Further, if the interval period is less than or equal to the valid period, it is determined that the first resource animation in the memory of the terminal is within the valid period. In some embodiments, if the interval period is greater than the valid period, it is determined that the first resource animation in the memory of the terminal is not within the valid period.

The terminal device may obtain the first resource animation from the server before receiving the first original interaction message. In some embodiments, the terminal device may alternatively obtain the first resource animation from the server after receiving the first original interaction message. In some embodiments, the terminal device may alternatively obtain the first resource animation and the first original interaction message from the server simultaneously while receiving the first original interaction message. In some embodiments, the terminal device may alternatively locally generate the first resource animation instead of obtaining the first resource animation from the server.

In some embodiments, the terminal device may alternatively obtain a first resource sub-animation from the server instead of directly obtaining the first resource animation from the server, and superimpose the first resource sub-animation obtained from the server and a locally generated second resource sub-animation, to obtain the first resource animation. Both the first resource sub-animation and the second resource sub-animation may be considered as imageviews (namely, view controls). Superimposing the first resource sub-animation and the second resource sub-animation may be considered as superimposition of two imageviews (namely, superimposition of two images). The imageview of the second resource sub-animation covers the imageview of the first resource sub-animation. For example, a display range of the imageview of the second resource sub-animation may be the area range 41b in the foregoing embodiment corresponding to FIG. 4, and a display range of the imageview of the first resource sub-animation may be the area range 41a in the foregoing embodiment corresponding to FIG. 4.

The memory of the terminal may include a memory managed by a virtual image thumbnail manager (namely, a virtual image thumbnail component). The virtual image thumbnail manager may be configured to maintain a mapping relationship between an account identifier and a thumbnail (namely, a virtual image). Alternatively, the virtual image thumbnail manager may be configured to maintain a mapping relationship between an account identifier and a resource animation. The mapping relationship in the virtual image thumbnail manager may be configured for supporting a plurality of services in the application client. In this way, if the virtual image thumbnail manager has no mapping relationship required by a service, background downloading (for example, downloading the first resource animation from the server) may be triggered. Further, if the first resource animation is successfully downloaded, an update event is broadcast, and a plurality of services are indicated based on the update event, and a thumbnail is refreshed again. For example, one of the plurality of services may be updating a default resource animation as the first resource animation.

When receiving an animation obtaining request sent by the terminal device based on the object identifier, the server may generate the first resource animation, and then return the first resource animation to the terminal device. In some embodiments, the server may alternatively generate the first resource animation corresponding to a hot object image in advance. In this way, when the terminal device sends the animation obtaining request to the server based on the object identifier, the server may directly obtain the first resource animation generated in advance, to reduce a delay of obtaining the resource animation by the terminal device.

Operation S304: Display a second preview message in the message preview box.

The second preview message is determined based on a second original interaction message sent by the interaction object. Before displaying the second preview message in the target area, the terminal device may cancel displaying of the first preview message in the target area.

For a specific process in which the terminal device displays the second preview message in the message preview box, reference may be made to the foregoing descriptions of displaying the first preview message in the message preview box. Details are not described herein again.

Operation S305: Display, in the target area, a second resource animation including the virtual image.

The second resource animation is determined based on media content included in the second original interaction message and a media format of the media content. Before displaying the second resource animation in the target area, the terminal device may cancel displaying of the first resource animation in the target area. In some embodiments, the terminal device may alternatively simultaneously display the first resource animation and the second resource animation in the target area.

For a specific process in which the terminal device displays, in the target area, the second resource animation including the virtual image, reference may be made to the foregoing descriptions of displaying, in the target area, the first resource animation including the virtual image. Details are not described herein again.

When the second original interaction message is the same as the first original interaction message, the first resource animation is the same as the second resource animation. In some embodiments, when the second original interaction message is different from the first original interaction message, the first resource animation may be the same as the second resource animation, or the first resource animation may be different from the second resource animation. For example, when the second original interaction message is “[picture],” and the first original interaction message is “Look at a picture I took [picture],” the first resource animation is the same as the second resource animation. For another example, when the second original interaction message is “[picture],” and the first original interaction message is “[video],” the first resource animation is different from the second resource animation.

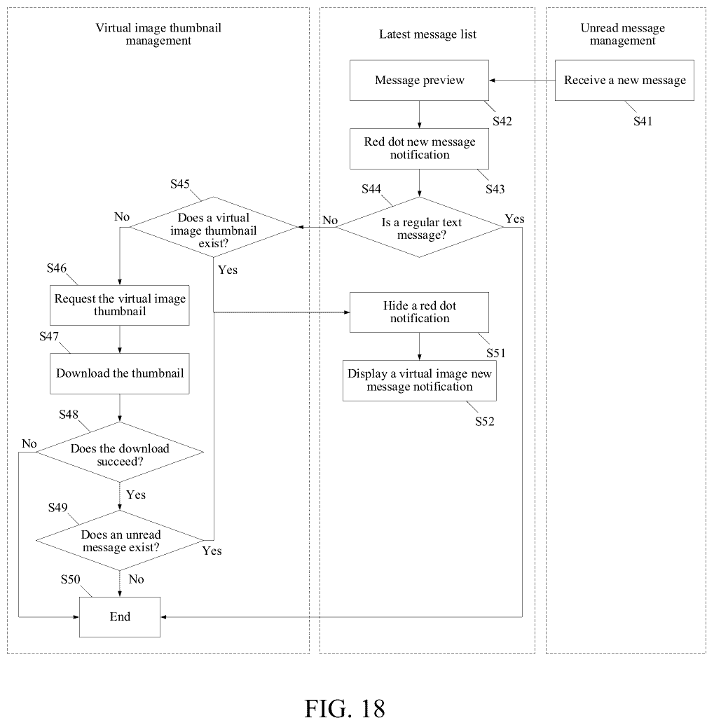

For ease of understanding, FIG. 18 is a schematic diagram showing a scenario of displaying a first resource animation according to an embodiment of this application. As shown in FIG. 18, the terminal device may include three management modules: virtual image thumbnail management module (namely, a virtual image thumbnail manager), a latest message list, and unread message management module (namely, an unread message manager). In other words, the terminal device may include three management components: a virtual image thumbnail management component, a latest message list component, and an unread message management component. A thumbnail refresh mechanism is uniformly managed by the virtual image thumbnail manager, and a thumbnail corresponding to a chat item is maintained by the virtual image thumbnail manager.

As shown in FIG. 18, when receiving a new message, the terminal device may receive the new message (for example, the first original interaction message) in operation S41. Further, the terminal device may perform operation S42, and perform message preview in the message list in operation S42, that is, may display the first preview message corresponding to the first original interaction message in the message list in operation S42. Further, the terminal device may perform operation S43, and perform a red dot new message notification in operation S43, that is, may display the preset message resource in the message preview box of the message list in operation S43. Further, the terminal device may perform operation S44, and determine whether the first original interaction message is a regular text message in operation S44, where the regular text message herein may be an interaction message that does not include document content, picture content, sticker content, video content, audio content, gift content, red packet content, and poke content.

Further, as shown in FIG. 18, if the first original interaction message is the regular text message (that is, the first original interaction message does not include the document content, the picture content, the sticker content, the video content, the audio content, the gift content, the red packet content, and the poke content), the terminal device may perform operation S50, where operation S50 indicates that the procedure ends.

In some embodiments, as shown in FIG. 18, if the first original interaction message is not the regular text message (that is, the first original interaction message includes the document content, the picture content, the sticker content, the video content, the audio content, the gift content, the red packet content, or the poke content), the terminal device may perform operation S45, and determine whether a virtual image thumbnail exists in the memory of the terminal in operation S45, that is, determine whether the virtual image corresponding to the interaction object exists in the memory of the terminal, that is, determine whether the first resource animation including the virtual image corresponding to the interaction object exists.

Further, as shown in FIG. 18, if the first resource animation including the virtual image exists in the memory of the terminal, the terminal device may perform operation S51 when there is an unread message, and hide a red dot prompt in operation S51, that is, cancel displaying of the preset message resource. Further, the terminal device may perform operation S52, and present a virtual image new message prompt in operation S52, that is, display the first resource animation including the virtual image.

In some embodiments, as shown in FIG. 18, if the first resource animation including the virtual image does not exist in the memory of the terminal, the terminal device may perform operation S46, and request the virtual image thumbnail from the server in operation S46, that is, obtain the first resource animation from the server by using a uniform resource locator (URL) of the virtual image thumbnail. Further, the terminal device may perform operation S47, and download the thumbnail in operation S47, that is, download the first resource animation from the server. Further, the terminal device may perform operation S48, and determine, in operation S48, whether the first resource animation is successfully downloaded.

Further, as shown in FIG. 18, if the first resource animation is successfully downloaded, the terminal device may perform operation S49, and determine, in operation S49, whether the application client has an unread message for the interaction object. Further, if the application client has the unread message for the interaction object, the terminal device may perform operation S51, and hide the red dot prompt in operation S51, that is, cancel displaying of the preset message resource. Further, the terminal device may perform operation S52, and present the virtual image new message prompt in operation S52, that is, display the first resource animation including the virtual image.

In some embodiments, as shown in FIG. 18, because the terminal device may respond to a trigger operation on the message preview box, the application client may have no unread message for the interaction object. If the application client has no unread message for the interaction object, the terminal device may perform operation S50, where operation S50 indicates that the procedure ends.

In some embodiments, as shown in FIG. 18, due to network or other reasons, the first resource animation may fail to be downloaded. If the first resource animation fails to be downloaded, the terminal device may perform operation S50, where operation S50 indicates that the procedure ends.

Operation S306: If the first original interaction message and the second original interaction message meet a message superimposition condition, display, in the application interface, a third resource animation jointly associated with the first original interaction message and the second original interaction message.

Specifically, if the first original interaction message and the second original interaction message meet the message superimposition condition, the terminal device may display, in the target area of the message preview box, the first resource sub-animation formed by the virtual image corresponding to the interaction object. Further, the terminal device may display, in the target area, a third resource sub-animation that is formed by the message virtual resource associated with the first original interaction message and a message virtual resource associated with the second original interaction message and that may be configured for interacting with the virtual image. The first resource sub-animation and the third resource sub-animation may be collectively referred to as the third resource animation jointly associated with the first original interaction message and the second original interaction message.

Before displaying the third resource animation in the target area, the terminal device may cancel displaying of the second resource animation in the target area. In some embodiments, when receiving the second original interaction message, the terminal device may alternatively determine whether the first original interaction message and the second original interaction message meet the message superimposition condition, and then directly display the third resource animation in the application interface without displaying the second resource animation (that is, operation S305 does not need to be performed).

In some embodiments, if the first original interaction message and the second original interaction message meet the message superimposition condition, the terminal device may display, in the target area of the message preview box, the first resource sub-animation formed by the virtual image corresponding to the interaction object. Further, the terminal device may display, in the target area, a fourth resource sub-animation that is formed by an update message virtual resource (for example, a ribbon or a star) and that may be configured for interacting with the virtual image. The first resource sub-animation and the fourth resource sub-animation may be collectively referred to as the third resource animation jointly associated with the first original interaction message and the second original interaction message. In this case, before displaying the third resource animation in the target area, the terminal device may cancel displaying of the second resource animation in the target area, or simultaneously display the first resource animation, the second resource animation, and the third resource animation in the target area.

The terminal device may obtain a first message sending timestamp of the first original interaction message and a second message sending timestamp of the second original interaction message, and determine a time interval between the first message sending timestamp and the second message sending timestamp. Further, if the time interval is less than or equal to a duration threshold, the terminal device may determine a relationship between the message superimposition condition and the first original interaction message and the second original interaction message according to a semantic similarity between the first original interaction message and the second original interaction message. In some embodiments, if the time interval is greater than the duration threshold, the terminal device may determine that the first original interaction message and the second original interaction message do not meet the message superimposition condition. A specific value of the duration threshold is not limited in embodiments of this application. For example, the duration threshold may be equal to 0.85 seconds.

A specific process of determining the relationship between the message superimposition condition and the first original interaction message and the second original interaction message according to the semantic similarity between the first original interaction message and the second original interaction message may be described as: The terminal device may separately input the first original interaction message and the second original interaction message to a semantic analysis model, separately perform feature extraction on the first original interaction message and the second original interaction message by using the semantic analysis model, and output a first message feature corresponding to the first original interaction message and a second message feature corresponding to the second original interaction message. Further, the terminal device may determine a feature similarity between the first message feature and the second message feature, and determine the feature similarity as the semantic similarity between the first original interaction message and the second original interaction message. Further, if the semantic similarity is greater than or equal to a similarity threshold, the terminal device may determine that the first original interaction message and the second original interaction message meet the message superimposition condition. In some embodiments, if the semantic similarity is less than the similarity threshold, the terminal device may determine that the first original interaction message and the second original interaction message do not meet the message superimposition condition.

The semantic analysis model is generated by performing iterative training on an initial semantic analysis model. A model type of the semantic analysis model is not limited in embodiments of this application. For example, the semantic analysis model may be a bidirectional encoder representation from transformer (BERT) model or a robust optimized BERT pre-training approach (RoBERTa).

It can be learned that, in embodiments of this application, the first preview message corresponding to the first original interaction message may be displayed in the message preview box of the application interface, and the first resource animation including the virtual image corresponding to the interaction object is then displayed in the target area of the message preview box. Similarly, in embodiments of this application, the second preview message corresponding to the second original interaction message may be displayed in the message preview box of the application interface, and the second resource animation including the virtual image corresponding to the interaction object is then displayed in the target area of the message preview box. Further, if the first original interaction message and the second original interaction message meet the message superimposition condition, the third resource animation jointly associated with the first original interaction message and the second original interaction message is displayed in the application interface. Because different first resource animations and second resource animations (namely, adaptability and diversity) may be generated for different interaction objects, in embodiments of this application, a personalized resource animation presentation manner may be implemented, and a new message notification manner may be enriched based on the first resource animation, the second resource animation, and the third resource animation.

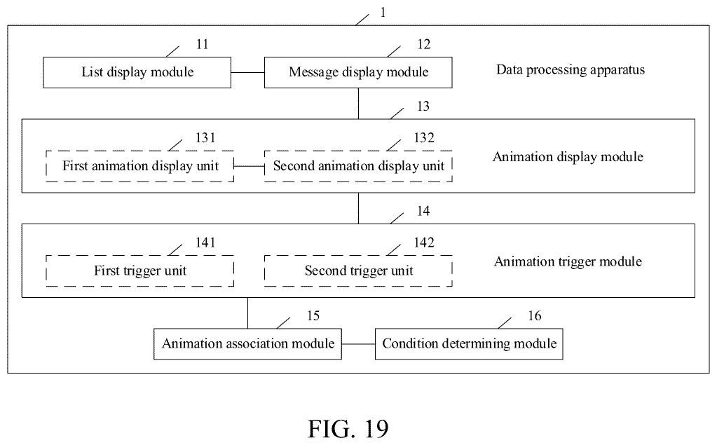

Further, FIG. 19 is a schematic structural diagram of a data processing apparatus according to an embodiment of this application. The data processing apparatus 1 may include: a list display module 11, a message display module 12, an animation display module 13, and an animation trigger module 14. Further, the data processing apparatus 1 may further include: an animation association module 15 and a condition determining module 16.

The list display module 11 is configured to display a message list in an application interface, the message list including a message preview box associated with an interaction object, and the message preview box including an avatar area and a target area that does not overlap the avatar area.

The message display module 12 is configured to display a first preview message in the message preview box, the first preview message being generated based on a first original interaction message sent by the interaction object.

The message display module 12 is specifically configured to obtain a quantity of unread messages and a latest message body that are for the interaction object from a message management database according to an object identifier of the interaction object.

The message display module 12 is specifically configured to perform accumulation processing on the quantity of unread messages according to the first original interaction message, to obtain an updated quantity of unread messages.

The message display module 12 is specifically configured to update the latest message body according to the first original interaction message, to obtain an updated latest message body.

The message display module 12 is specifically configured to display, based on the updated quantity of unread messages and the updated latest message body, the first preview message corresponding to the first original interaction message in the message preview box.

The message display module 12 is further specifically configured to: in response to a trigger operation on a first resource animation, zero out the updated quantity of unread messages, to obtain an initialized quantity of unread messages.

The message display module 12 is further specifically configured to initialize the updated latest message body, to obtain an initialized latest message body.

The message display module 12 is further specifically configured to cancel displaying of the first resource animation in the target area based on the initialized quantity of unread messages and the initialized latest message body.

The animation display module 13 is configured to display, in the target area of the message preview box, the first resource animation including a virtual image corresponding to the interaction object, the first resource animation being determined based on media content included in the first original interaction message and a media format of the media content.

The first resource animation includes a first resource sub-animation and a second resource sub-animation.

The animation display module 13 includes: a first animation display unit 131 and a second animation display unit 132.

The first animation display unit 131 is configured to display, in the target area of the message preview box, the first resource sub-animation formed by the virtual image corresponding to the interaction object.

The second animation display unit 132 is configured to display the second resource sub-animation in the target area, the second resource sub-animation being generated based on a message virtual resource that is configured for interacting with the virtual image. The message virtual resource is determined based on the media content included in the first original interaction message and the media format of the media content.

The message virtual resource includes an image message virtual resource.

The second animation display unit 132 is specifically configured to: if the media format of the media content included in the first original interaction message is a media format corresponding to image-type content, determine the media content included in the first original interaction message as the image message virtual resource.

The second animation display unit 132 is specifically configured to display the second resource sub-animation in the target area, the second resource sub-animation being generated based on the image message virtual resource that is configured for interacting with the virtual image.

The message virtual resource includes a file message virtual resource.

The second animation display unit 132 is specifically configured to: if the media format of the media content included in the first original interaction message is a media format corresponding to file-type content, obtain the file message virtual resource indicated by the media content included in the first original interaction message.

The second animation display unit 132 is specifically configured to display the second resource sub-animation in the target area, the second resource sub-animation being generated based on the file message virtual resource that is configured for interacting with the virtual image.

The message virtual resource includes a video message virtual resource.

The second animation display unit 132 is specifically configured to: if the media format of the media content included in the first original interaction message is a media format corresponding to video-type content, obtain a preview video frame in the media content included in the first original interaction message, and determine the preview video frame as the video message virtual resource.

The second animation display unit 132 is specifically configured to display the second resource sub-animation in the target area, the second resource sub-animation being generated based on the video message virtual resource that is configured for interacting with the virtual image.

For specific implementations of the first animation display unit 131 and the second animation display unit 132, reference may be made to the descriptions of operation S103 in the foregoing embodiment corresponding to FIG. 2, and the descriptions of operation S202 and operation S203 in the foregoing embodiment corresponding to FIG. 5. Details are not described herein again.

The animation display module 13 is specifically configured to display a preset message resource in the target area of the message preview box.

The animation display module 13 is specifically configured to: if the first resource animation including the virtual image corresponding to the interaction object does not exist in a memory of a terminal, obtain the first resource animation from a server according to the object identifier of the interaction object.

The animation display module 13 is specifically configured to update the preset message resource in the target area based on the first resource animation.

The animation trigger module 14 is configured to execute, in response to the trigger operation on the first resource animation, a message service associated with the first original interaction message.

The animation display module 14 includes: a first trigger unit 141 and a second trigger unit 142.

The first trigger unit 141 is configured to: if the first resource animation is a triggerable resource animation, display, in response to the trigger operation on the first resource animation, media data associated with media content that is in the first original interaction message and that is in a triggerable media format.

The first resource animation includes a viewing message virtual resource.

The first trigger unit 141 is specifically configured to switch the application interface to a viewing interface in response to the trigger operation on the first resource animation.

The first trigger unit 141 is specifically configured to display, in the viewing interface, media data associated with media content that is in the first original interaction message and that is in a viewing media format. The viewing media format is a triggerable media format indicated by the viewing message virtual resource.

The first resource animation includes an audio message virtual resource.

The first trigger unit 141 is specifically configured to display, in response to the trigger operation on the first resource animation, a play progress corresponding to media content that is in the first original interaction message and that is in an audio media format. The audio media format is a triggerable media format indicated by the audio message virtual resource.

The first trigger unit 141 is further specifically configured to play, in response to a dragging operation on the play progress, the media content in the audio media format according to a dragged play progress.

The first resource animation includes a collection message virtual resource.

The first trigger unit 141 is specifically configured to display, in response to the trigger operation on the first resource animation, resource description information and a resource collection control that correspond to media content that is in the first original interaction message and that is in a collection media format. The collected media format is a triggerable media format indicated by the collection message virtual resource.

The first trigger unit 141 is further specifically configured to collect, in response to a trigger operation on the resource collection control, an animation virtual resource indicated by the resource description information.

The second trigger unit 142 is configured to: if the first resource animation is an untriggerable resource animation, display, in response to the trigger operation on the first resource animation, an interaction area associated with the interaction object.

The second trigger unit 142 is configured to display the first original interaction message in the interaction area.

For specific implementations of the first trigger unit 141 and the second trigger unit 142, reference may be made to the descriptions of operation S104 in the foregoing embodiment corresponding to FIG. 2, and the descriptions of operation S205 to operation S207 in the foregoing embodiment corresponding to FIG. 5. Details are not described herein again.

In some embodiments, the animation association module 15 is configured to display a second preview message in the message preview box. The second preview message is determined based on a second original interaction message sent by the interaction object.

The animation association module 15 is configured to display, in the target area, a second resource animation including the virtual image. The second resource animation is determined based on media content included in the second original interaction message and a media format of the media content.

The animation association module 15 is configured to: if the first original interaction message and the second original interaction message meet a message superimposition condition, display, in the application interface, a third resource animation jointly associated with the first original interaction message and the second original interaction message.

In some embodiments, the condition determining module 16 is configured to obtain a first message sending timestamp of the first original interaction message and a second message sending timestamp of the second original interaction message, and determine a time interval between the first message sending timestamp and the second message sending timestamp.

The condition determining module 16 is configured to: if the time interval is less than or equal to a duration threshold, determine a relationship between the message superimposition condition and the first original interaction message and the second original interaction message according to a semantic similarity between the first original interaction message and the second original interaction message.

The condition determining module 16 is configured to: if the time interval is greater than the duration threshold, determine that the first original interaction message and the second original interaction message do not meet the message superimposition condition.

The condition determining module 16 is specifically configured to separately input the first original interaction message and the second original interaction message to a semantic analysis model, separately perform feature extraction on the first original interaction message and the second original interaction message by using the semantic analysis model, and output a first message feature corresponding to the first original interaction message and a second message feature corresponding to the second original interaction message.

The condition determining module 16 is specifically configured to determine a feature similarity between the first message feature and the second message feature, and determine the feature similarity as the semantic similarity between the first original interaction message and the second original interaction message.

The condition determining module 16 is specifically configured to: if the semantic similarity is greater than or equal to a similarity threshold, determine that the first original interaction message and the second original interaction message meet the message superimposition condition.

The condition determining module 16 is specifically configured to: if the semantic similarity is less than the similarity threshold, determine that the first original interaction message and the second original interaction message do not meet the message superimposition condition.

For specific implementations of the list display module 11, the message display module 12, the animation display module 13, and the animation trigger module 14, reference may be made to the descriptions of operation S101 to operation S104 in the foregoing embodiment corresponding to FIG. 2, and the descriptions of operation S201 to operation S207 in the foregoing embodiment corresponding to FIG. 5. Details are not described herein again. For specific implementations of the animation association module 15 and the condition determining module 16, reference may be made to the descriptions of operation S304 to operation S306 in the foregoing embodiment corresponding to FIG. 16. Details are not described herein again. In addition, beneficial effects achieved by using the same method are not described herein again.

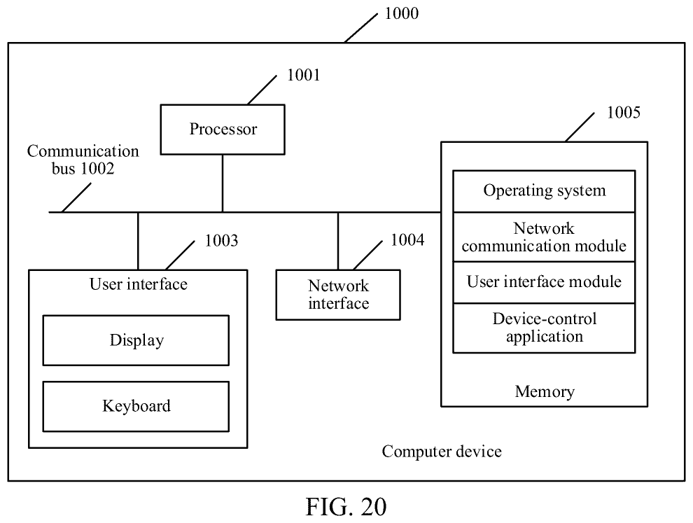

Further, FIG. 20 is a schematic structural diagram of a computer device according to an embodiment of this application. The computer device may be a terminal device or a server. As shown in FIG. 20, the computer device 1000 may include: a processor 1001, a network interface 1004, and a memory 1005. The computer device 1000 may further include: a user interface 1003 and at least one communication bus 1002. The communication bus 1002 is configured to implement connection and communication between the components. In some embodiments, the user interface 1003 may include a display, a keyboard, and an optional user interface 1003 may further include a standard wired interface and a wireless interface. The network interface 1004 may include a standard wired interface and a standard wireless interface (for example, a Wi-Fi interface). The memory 1005 may be a high-speed RAM memory, or may be a non-volatile memory, for example, at least one magnetic disk memory. In some embodiments, the memory 1005 may alternatively be at least one storage apparatus that is located far away from the processor 1001. As shown in FIG. 20, the memory 1005 used as a computer-readable storage medium may include an operating system, a network communication module, a user interface module, and a device-control application program.

In the computer device 1000 shown in FIG. 20, the network interface 1004 may provide a network communication function. The user interface 1003 is mainly configured to provide an input interface for a user. The processor 1001 may be configured to invoke a device-controlled application program stored in the memory 1005, to implement:
displaying a message list in an application interface, the message list including a message preview box associated with an interaction object;
displaying a first preview message in the message preview box, the first preview message being determined based on a first original interaction message sent by the interaction object;
displaying, in a target area of the message preview box, a first resource animation including a virtual image corresponding to the interaction object, the target area not overlapping an avatar area in the message preview box, and the first resource animation being determined based on media content included in the first original interaction message and a media format of the media content; and
executing, in response to a trigger operation on the first resource animation, a message service associated with the first original interaction message.

The computer device 1000 described in embodiments of this application can implement the descriptions of the data processing method in the foregoing embodiment corresponding to FIG. 2, FIG. 5, or FIG. 16, and can also implement the descriptions of the data processing apparatus 1 in the foregoing embodiment corresponding to FIG. 19. Details are not described herein again. In addition, beneficial effects achieved by using the same method are not described herein again.

In addition, an embodiment of this application further provides a computer-readable storage medium. The computer-readable storage medium stores a computer program executed by the data processing apparatus 1 mentioned above. When executing the computer program, a processor can perform the descriptions of the data processing method in the foregoing embodiment corresponding to FIG. 2, FIG. 5, or FIG. 16. Therefore, details are not described herein again. In addition, beneficial effects achieved by using the same method are not described herein again. For technical details that are not disclosed in the embodiments of the computer-readable storage medium of this application, reference is made to the method embodiments of this application.

In addition, an embodiment of this application further provides a computer program product. The computer program product may include a computer program, and the computer program may be stored in a computer-readable storage medium. A processor of a computer device reads the computer program from the computer-readable storage medium, and the processor may execute the computer program, to enable the computer device to perform the descriptions of the data processing method in the foregoing embodiment corresponding to FIG. 2, FIG. 5, or FIG. 16. Therefore, details are not described herein again. In addition, beneficial effects achieved by using the same method are not described herein again. For technical details that are not disclosed in the computer program product embodiments of this application, reference is made to the descriptions of the method embodiments of this application.

A person of ordinary skill in the art is to understand that all or a part of the processes of the method in the foregoing embodiment may be implemented by a program instructing relevant hardware. The program may be stored in a computer readable storage medium. When the program is run, the processes of the method in the foregoing embodiment are performed. The foregoing storage medium may be a magnetic disk, an optical disc, a read-only memory (ROM), or a random access memory (RAM).

What are disclosed above are merely embodiments of this application, and certainly are not intended to limit the protection scope of this application. Therefore, equivalent variations made in accordance with the claims of this application shall fall within the scope of this application.

What is claimed is:

1. A data processing method comprising:
displaying a message list in an application interface, the message list including a message preview box that includes an avatar area and a target area not overlapping the avatar area;
displaying a preview message in the message preview box, the preview message being generated based on an original interaction message;
displaying, in the target area, a resource animation including a virtual image, the resource animation being determined based on media content in the original interaction message and a media format of the media content; and
executing, in response to a trigger operation on the resource animation, a message service associated with the original interaction message.

2. The method according to claim 1, wherein executing the message service includes:
in response to the resource animation being untriggerable, displaying an interaction area; and
displaying the original interaction message in the interaction area.

3. The method according to claim 1, wherein executing the message service includes:
in response to the resource animation being triggerable, displaying media data associated with media content that is in the original interaction message and that is in a triggerable media format.

4. The method according to claim 3, wherein:
the resource animation includes a viewing message virtual resource; and
displaying the media data associated with media content that is in the original interaction message and that is in the triggerable media format includes:
switching the application interface to a viewing interface; and
displaying, in the viewing interface, media data associated with media content that is in the original interaction message and that is in a viewing media format indicated by the viewing message virtual resource.

5. The method according to claim 3, wherein:
the resource animation includes an audio message virtual resource; and
displaying the media data associated with the media content that is in the original interaction message and that is in the triggerable media format includes:
displaying a play progress corresponding to media content that is in the original interaction message and that is in an audio media format indicated by the audio message virtual resource;
the method further comprising:
playing, in response to a dragging operation on the play progress, the media content in the audio media format according to a dragged play progress.

6. The method according to claim 3, wherein:
the resource animation includes a collection message virtual resource; and
displaying the media data associated with the media content that is in the original interaction message and that is in the triggerable media format includes:
displaying resource description information and a resource collection control that correspond to media content that is in the original interaction message and that is in a collection media format indicated by the collection message virtual resource;
the method further comprising:
collecting, in response to a trigger operation on the resource collection control, an animation virtual resource indicated by the resource description information.

7. The method according to claim 1, wherein:
the resource animation includes:
a first resource sub-animation including the virtual image; and
a second resource sub-animation generated based on a message virtual resource configured for interacting with the virtual image, the message virtual resource being determined based on the media content and the media format of the media content; and
displaying the resource animation includes displaying the first resource sub-animation and the second resource sub-animation in the target area.

8. The method according to claim 7, further comprising:
in response to the media format of the media content in the original interaction message being a media format corresponding to image-type content, determining the media content in the original interaction message as an image message virtual resource to be included in the message virtual resource and configured for interacting with the virtual image; and
generating the second resource sub-animation based on the image message virtual resource.

9. The method according to claim 7, further comprising:
in response to the media format of the media content in the original interaction message being a media format corresponding to file-type content, obtaining a file message virtual resource indicated by the media content in the original interaction message to be included in the message virtual resource and configured for interacting with the virtual image; and
generating the second resource sub-animation based on the file message virtual resource.

10. The method according to claim 7, further comprising:
in response to the media format of the media content in the original interaction message being a media format corresponding to video-type content, obtaining a preview video frame in the media content in the first original interaction message as a video message virtual resource to be included in the message virtual resource and configured for interacting with the virtual image; and
generating the second resource sub-animation based on the video message virtual resource.

11. The method according to claim 1, wherein displaying the resource animation includes:
displaying a preset message resource;
in response to the resource animation not existing in a memory of a terminal, obtaining the resource animation from a server according to an object identifier; and
updating the preset message resource based on the resource animation.

12. The method according to claim 1, wherein displaying the preview message includes:
obtaining, based on an object identifier, a quantity of unread messages and a latest message body that are for an interaction object associated with the object identifier from a message management database;
performing accumulation processing on the quantity of unread messages according to the original interaction message, to obtain an updated quantity of unread messages;
updating the latest message body according to the original interaction message, to obtain an updated latest message body; and
displaying the preview message based on the updated quantity of unread messages and the updated latest message body.

13. The method according to claim 12, further comprising:
in response to the trigger operation on the resource animation, zeroing out the updated quantity of unread messages, to obtain an initialized quantity of unread messages;
initializing the updated latest message body, to obtain an initialized latest message body; and
canceling displaying of the resource animation based on the initialized quantity of unread messages and the initialized latest message body.

14. The method according to claim 1,
wherein the preview message is a first preview message, the original interaction message is a first original interaction message, and the resource animation is a first resource animation;
the method further comprising:
displaying a second preview message in the message preview box, the second preview message being determined based on a second original interaction message;
displaying, in the target area, a second resource animation comprising the virtual image; the second resource animation being determined based on media content in the second original interaction message and a media format of the media content in the second original interaction message; and
in response to the first original interaction message and the second original interaction message meeting a message superimposition condition, displaying, in the application interface, a third resource animation jointly associated with the first original interaction message and the second original interaction message.

15. The method according to claim 14, further comprising:
determining a time interval between a first message sending timestamp of the first original interaction message and a second message sending timestamp of the second original interaction message;
in response to the time interval being less than or equal to a duration threshold, determining, according to a semantic similarity between the first original interaction message and the second original interaction message, a relationship between:
the message superimposition condition, and
the first original interaction message and the second original interaction message; and
in response to the time interval being greater than the duration threshold, determining that the first original interaction message and the second original interaction message do not meet the message superimposition condition.

16. The method according to claim 15, wherein determining the relationship includes:
separately performing feature extraction on the first original interaction message and the second original interaction message using a semantic analysis model to determine a first message feature corresponding to the first original interaction message and a second message feature corresponding to the second original interaction message;
determining a feature similarity between the first message feature and the second message feature as the semantic similarity between the first original interaction message and the second original interaction message;
in response to the semantic similarity being greater than or equal to a similarity threshold, determining that the first original interaction message and the second original interaction message meet the message superimposition condition; and
in response to the semantic similarity being less than the similarity threshold, determining that the first original interaction message and the second original interaction message do not meet the message superimposition condition.

17. A computer device comprising:
a processor; and
a memory storing a computer program that, when executed by the processor, causes the computer device to:
display a message list in an application interface, the message list including a message preview box that includes an avatar area and a target area not overlapping the avatar area;
display a preview message in the message preview box, the preview message being generated based on an original interaction message;
display, in the target area, a resource animation including a virtual image, the resource animation being determined based on media content in the original interaction message and a media format of the media content; and
execute, in response to a trigger operation on the resource animation, a message service associated with the original interaction message.

18. The computer device according to claim 17, wherein the computer program, when executed by the processor, further causes the computer device to, when executing the message service:
in response to the resource animation being untriggerable, display an interaction area; and
display the original interaction message in the interaction area.

19. The computer device according to claim 17, wherein the computer program, when executed by the processor, further causes the computer device to, when executing the message service:
in response to the resource animation being triggerable, display media data associated with media content that is in the original interaction message and that is in a triggerable media format.

20. A non-transitory computer-readable storage medium storing a computer program that, when executed by a processor, causes a computer device including the processor to:
display a message list in an application interface, the message list including a message preview box that includes an avatar area and a target area not overlapping the avatar area;
display a preview message in the message preview box, the preview message being generated based on an original interaction message;
display, in the target area, a resource animation including a virtual image, the resource animation being determined based on media content in the original interaction message and a media format of the media content; and
execute, in response to a trigger operation on the resource animation, a message service associated with the original interaction message.
